(19) United States
(12) Patent Application Publication
(10) Pub. No.: US 2026/0303446 A1
(43) Pub. Date: Oct. 1, 2026

(54) GATEWAY CONFIGURATION METHOD AND ELECTRONIC DEVICE

(71) Applicants: CHENGDU BOE SMART TECHNOLOGY CO., LTD., Sichuan (CN); BOE Technology Group Co., Ltd., Beijing (CN); Beijing BOE Technology Development Co., Ltd., Beijing (CN)

(72) Inventor: Lang YANG, Beijing (CN)

(21) Appl. No.: 18/993,081

(22) PCT Filed: Apr. 27, 2023
(86) PCT No.: PCT/CN2023/091191

§ 371 Date: Jan. 10, 2025

(51) Int. Cl. H04L 41/0803; G06F 3/04842; G06F 3/0486; H04L 12/66

(52) U.S. Cl. CPC H04L 41/0803; G06F 3/04842; G06F 3/0486; H04L 12/66

(57) ABSTRACT

A gateway configuration method and an electronic device, for use in implementing gateway configuration of a visual interface by dragging a service module, effectively reducing the operation and maintenance difficulty. The method includes: displaying a service module in a visual interface, the visual interface includes a published-service area and an unpublished-service area, the published-service area is used for displaying a service module of a published service, and the unpublished-service area is used for displaying a service module of an unpublished service; and in response to an operation of a user dragging a target service module from the unpublished-service area to the published-service area, performing corresponding gateway configuration on the target service module, and running a service corresponding to the target service module, the target service module is selected by the user from service modules that are not running in the unpublished-service area.

### CROSS-REFERENCE TO RELATED APPLICATION

This application is a National Stage of International Application No. PCT/CN2023/091191, filed Apr. 27, 2023, which is hereby incorporated by reference in its entirety.

### TECHNICAL FIELD

The present disclosure relates to the technical field of service maintenance, and in particular to a gateway configuration method and an electronic device.

### BACKGROUND

Gateway mainly exists in the form of network protection, route forwarding and other functions in network transmission. In the development of software projects, the use of gateways is mostly combined with micro-services. As the entrance of the whole service, it takes into account a series of functions such as authentication and authorization, routing and forwarding, and load balancing. For users, most of them use the gateway configuration to manage and maintain micro-services.

The current gateway configuration is usually managed through a form, which is not convenient for later maintenance.

### SUMMARY

In a first aspect, embodiments of the present disclosure provide a gateway configuration method, the method includes:
displaying a service module in a visualization interface, where the visualization interface includes a published area and an unpublished area, the published area is used for displaying a service module of a published service, the unpublished area is used for displaying a service module of an unpublished service;
in response to a user operation of dragging and dropping a target service module from the unpublished area to the published area, configuring a corresponding gateway for the target service module and operating a service corresponding to the target service module, where the target service module is selected by the user from service modules that are not operating in the unpublished area.

In a second aspect, embodiments of the present disclosure provide an electronic device including a processor and a memory, the memory for storing programs executable by the processor, the processor for reading the programs in the memory and performing the following steps:
displaying a service module in a visualization interface, where the visualization interface includes a published area and an unpublished area, the published area is used for displaying a service module of a published service, the unpublished area is used for displaying a service module of an unpublished service;
in response to a user operation of dragging and dropping a target service module from the unpublished area to the published area, configuring a corresponding gateway for the target service module and operating a service corresponding to the target service module, where the target service module is selected by the user from service modules that are not operating in the unpublished area.

In a third aspect, embodiments of the present disclosure further provide a gateway configuration device, the device includes:
a display service unit, for displaying a service module in a visualization interface, where the visualization interface includes a published area and an unpublished area, the published area is used for displaying a service module of a published service, the unpublished area is used for displaying a service module of an unpublished service;
a gateway configuration unit, for configuring a corresponding gateway for the target service module and operating a service corresponding to the target service module in response to a user operation of dragging and dropping a target service module from the unpublished area to the published area, where the target service module is selected by the user from service modules that are not operating in the unpublished area.

In a fourth aspect, embodiments of the present disclosure further provide a computer storage media storing a computer program thereon, wherein the program, when executed by a processor, implements the steps of the method described in the first aspect.

### BRIEF DESCRIPTION OF FIGURES

In order to more clearly illustrate the technical solutions in embodiments of the present disclosure, a brief introduction will be given below to the drawings needed to be used in the description of embodiments. Obviously, the drawings in the following description are only some embodiments of the present disclosure. Those of ordinary skill in the art can also obtain other drawings based on these drawings without exerting creative efforts.

FIG. 1A is a schematic diagram of a gateway configuration interface in the form of a form provided by embodiments of the present disclosure.

FIG. 1B is a schematic diagram of a gateway configuration interface in the form of a form provided by embodiments of the present disclosure.

FIG. 2 is a flowchart of a specific implementation of a gateway configuration method provided by embodiments of the present disclosure.

FIG. 3A is a schematic diagram of a gateway configuration management interface provided by the embodiment of the disclosure.

FIG. 3B is a schematic diagram of a gateway configuration management interface provided by the embodiment of the disclosure.

FIG. 3C is a schematic diagram of a gateway configuration management interface provided by the embodiment of the disclosure.

FIG. 3D is a schematic diagram of a gateway configuration management interface provided by the embodiment of the disclosure.

FIG. 3E is a schematic diagram of a service level invocation provided by embodiments of the present disclosure.

FIG. 4 is a schematic diagram of an anonymous gateway configuration interface provided by an embodiment of the present disclosure.

FIG. 5 is a schematic diagram of a route matching function interface provided by an embodiment of the present disclosure.

FIG. 6 is a schematic diagram of a service of a visualization interface provided by embodiments of the present disclosure.

FIG. 7 is a schematic diagram of a gateway configuration interface for displaying different running states provided by embodiments of the present disclosure.

FIG. 8 is a schematic diagram of a gateway configuration interface for displaying connection states provided by embodiments of the present disclosure.

FIG. 9 is a schematic diagram of a gateway configuration interface in which a sub-area corresponds to a service module color provided by an embodiment of the present disclosure.

FIG. 10A is a schematic diagram of the initial configuration of a gateway management interface provided by embodiments of the present disclosure.

FIG. 10B is a schematic diagram of the initial configuration of a gateway management interface provided by embodiments of the present disclosure.

FIG. 10C is a schematic diagram of a completed gateway interface configuration provided by embodiments of the present disclosure.

FIG. 10D is a schematic diagram of a completed gateway interface configuration provided by embodiments of the present disclosure.

FIG. 11A is a schematic diagram of an auxiliary service configuration interface provided by an embodiment of the present disclosure.

FIG. 11B is a schematic diagram of a function service configuration interface provided by an embodiment of the present disclosure.

FIG. 11C is a schematic diagram of an invisible service configuration interface provided by an embodiment of the present disclosure.

FIG. 11D is a schematic diagram of an anonymous service configuration interface provided by an embodiment of the disclosure.

FIG. 12 shows a schematic diagram of a visualization interface having added an auxiliary service and an invisible service provided by an embodiment of the present disclosure.

FIG. 13A is a schematic diagram of a service publishing provided by embodiments of the present disclosure.

FIG. 13B is a schematic diagram of a service publishing provided by embodiments of the present disclosure.

FIG. 13C is an interface diagram where service publishing has been completed and is operating normally provided by an embodiment of the present disclosure.

FIG. 14A is an interface diagram for adding a function service provided by an embodiment of the present disclosure.

FIG. 14B is an interface diagram of a service publishing completed provided by the embodiment of the disclosure.

FIG. 15A is a schematic diagram of interface of the levels adjustment of a functional service that have been launched provided by embodiments of the disclosure.

FIG. 15B is a schematic diagram of interface of the levels adjustment of a functional service that have been launched provided by embodiments of the disclosure.

FIG. 16A is a service interface diagram formed after service offline provided by an embodiment of the present disclosure.

FIG. 16B is an interface diagram of a service module with multi-levels provided by an embodiment of the present disclosure.

FIG. 16C is an interface diagram for offline service provided by an embodiment of the present disclosure.

FIG. 17A is a schematic diagram of the configuration interface of an anonymous service provided by embodiments of the present disclosure.

FIG. 17B is a schematic diagram of the configuration interface of an anonymous service provided by embodiments of the present disclosure.

FIG. 18 is a flowchart of a gateway service operation principle provided by an embodiment of the present disclosure.

FIG. 19 is a schematic diagram of an electronic device provided by embodiments of the present disclosure.

FIG. 20 is a schematic diagram of a gateway configuration device provided by embodiments of the present disclosure.

### DETAILED DESCRIPTION

In order to make the purpose, technical solutions and advantages of embodiments of the present disclosure more clear, the technical solutions of the embodiments of the present disclosure will be clearly and completely described below in conjunction with the drawings of embodiments of the present disclosure. Obviously, the described embodiments are some, but not all, of the embodiments of the present disclosure. Based on the described embodiments of the present disclosure, all other embodiments obtained by those of ordinary skill in the art without creative efforts fall within the scope of the present disclosure.

The term “and/or” in embodiments of the present disclosure describes the association relationship of the association object, indicating that there can be three kinds of relationships, for example, A and/or B, which can indicate that there are three situations: A alone, A and B together, and B alone. The character “/” generally indicates that the associated object is an OR relationship.

The application scenarios described in embodiments of the present disclosure are for the purpose of more clearly illustrating the technical solutions of the embodiments of the present disclosure, and do not constitute a limitation of the technical solutions provided by the embodiments of the present disclosure, and a person of ordinary skill in the art may know that, with the emergence of new application scenarios, the technical solutions provided by the embodiments of the present disclosure are equally applicable to similar technical problems. In the description of the present disclosure, unless otherwise specified, “more than one” means two or more.

In this era of “Internet+”, computer systems are more and more closely related to our lives. More and more systems will be incorporated into computer system management, leading to a larger and larger software system. The whole system is becoming more and more complex with “single service->micro-service->cluster service”. After the service system becomes larger, it is necessary to ensure the high availability, performance, and concurrency of services. In addition to being ensured through service components (such as LVS and Nginx), the processing of services themselves is equally important. Gateway is created to solve such problems, and its importance can be seen. Therefore, errors are not allowed in the configuration and maintenance of the gateway to avoid service unavailability.

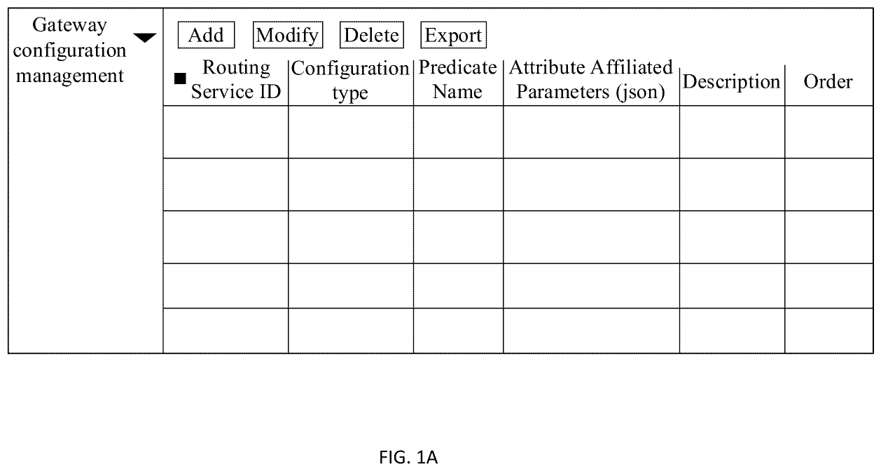

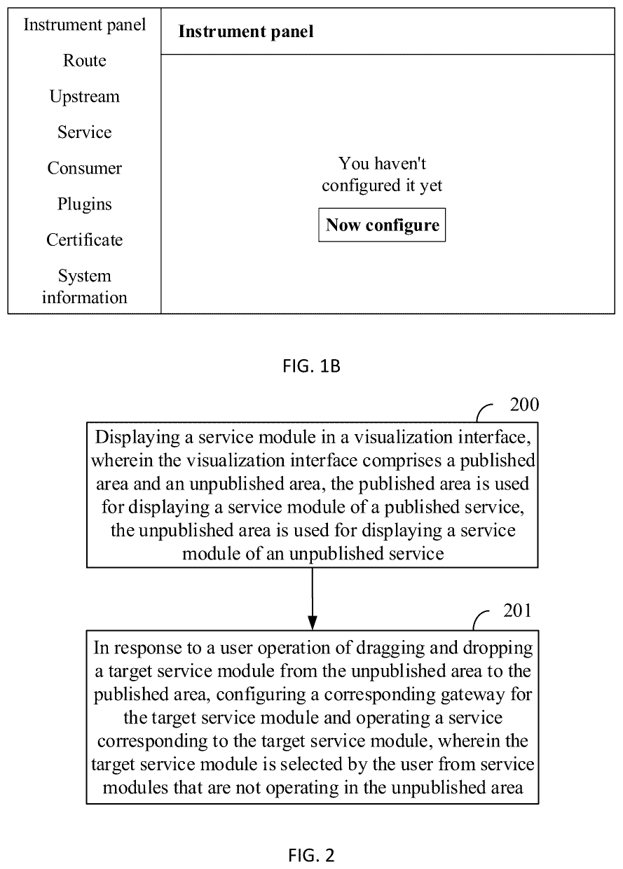

Gateway mainly exists in the form of network protection, route forwarding and other functions in network transmission. In the development of software projects, the use of gateways is mostly combined with micro-services. As the entrance of the whole service, it takes into account a series of functions such as authentication and authorization, routing and forwarding, and load balancing. But these are the underlying functions. For developers and users, most of them use the gateway configuration to manage and maintain micro-services. The current gateway configuration is usually managed through a form, which is not convenient for later maintenance. As shown in FIG. 1A to FIG. 1B, this embodiment provides schematic diagrams of a gateway configuration interface in the form of a form, in which the relevant functional interfaces such as route matching, gateway flow restriction, anonymous routing, etc. are separated. Although such configuration management interface can meet the needs of software use, it requires a lot of manpower for maintenance and management. In particular, the larger the micro-service system, the more obvious the problem.

Embodiments of the present disclosure provide a gateway configuration method, the core idea is to realize the gateway configuration of services by dragging and dropping the service module in the visualization interface, and this embodiment divides the visualization interface into two parts, one part of which is the published area for displaying the operating service module that has already been published, and the other part of which is the unpublished area for displaying the non-operating service module that has not yet been published. By dragging the unpublished service modules from the unpublished area to the published area, the online operation of the unpublished service modules can be achieved. The service module can be run and the corresponding gateway configuration can be performed to facilitate maintenance and reduce the difficulty of operation and maintenance.

As shown in FIG. 2, a specific implementation process of a gateway configuration method provided by the embodiment is shown as follows.

Step 200, displaying a service module in a visualization interface, where the visualization interface includes a published area and an unpublished area, the published area is used for displaying a service module of a published service, the unpublished area is used for displaying a service module of an unpublished service.

In the implementation, the service module in this embodiment is obtained by encapsulating the services to be configured in the system.

The embodiment divides the visualization interface into two major parts, one part is the published area, which is used to display the service modules of the published, on-line or operating services, and the other part is the unpublished area, which is used to display the service modules of the unpublished, off-line or stopped operating services. The unpublished services themselves do not exist, they only exist as service data and do not provide relevant functions to the public.

Optionally, the published area in this embodiment includes a plurality of sub-areas, each sub-area being used for displaying a service module of a different service type, and the plurality of sub-areas in this embodiment includes, but is not limited to, a functional sub-area, an anonymous sub-area, an auxiliary sub-area, an invisible sub-area, and a gateway sub-area.

The service modules in this embodiment are categorized as follows, depending on the type of service:
a functional service module, an anonymous service module, an auxiliary service module, an invisible service module, a gateway service module. Each service module of each service type corresponds to different obligations in the whole system, except for the gateway service module, the empowerment of other service modules comes from the gateway service itself.

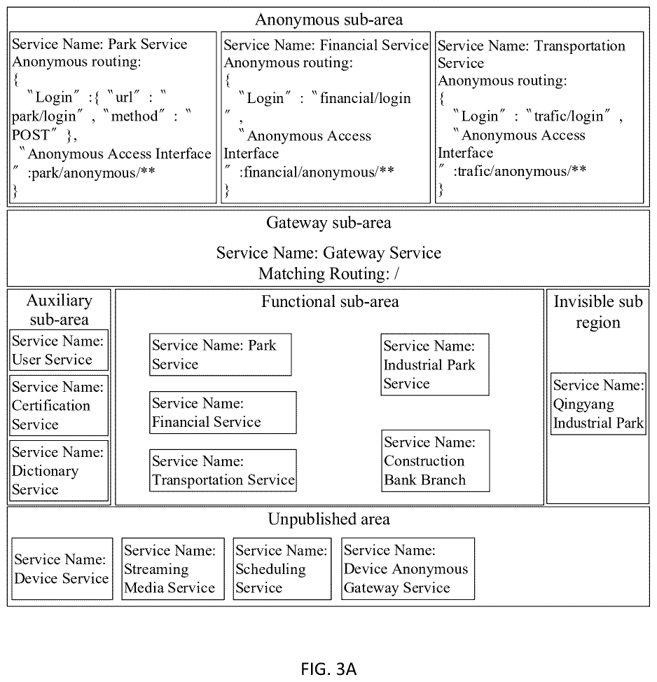

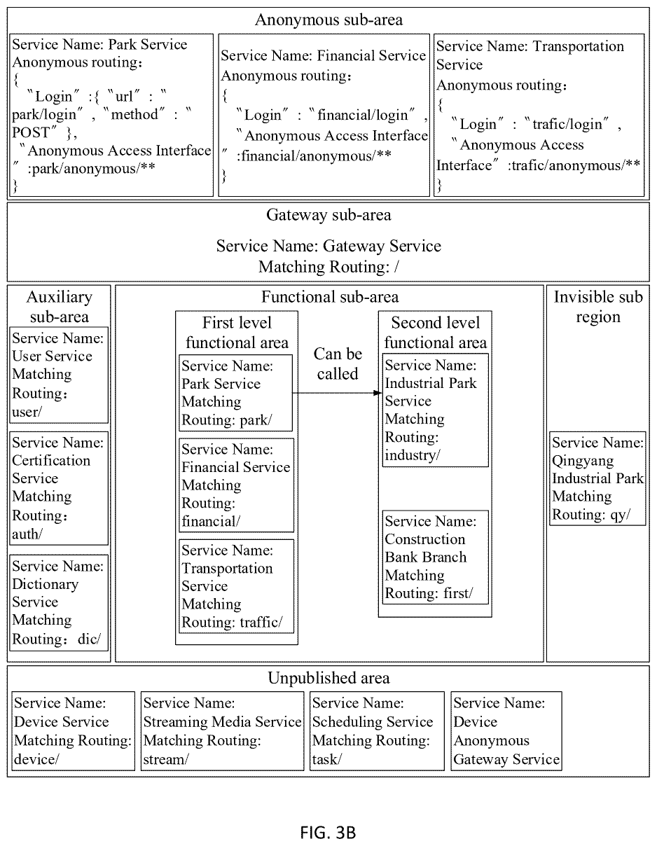

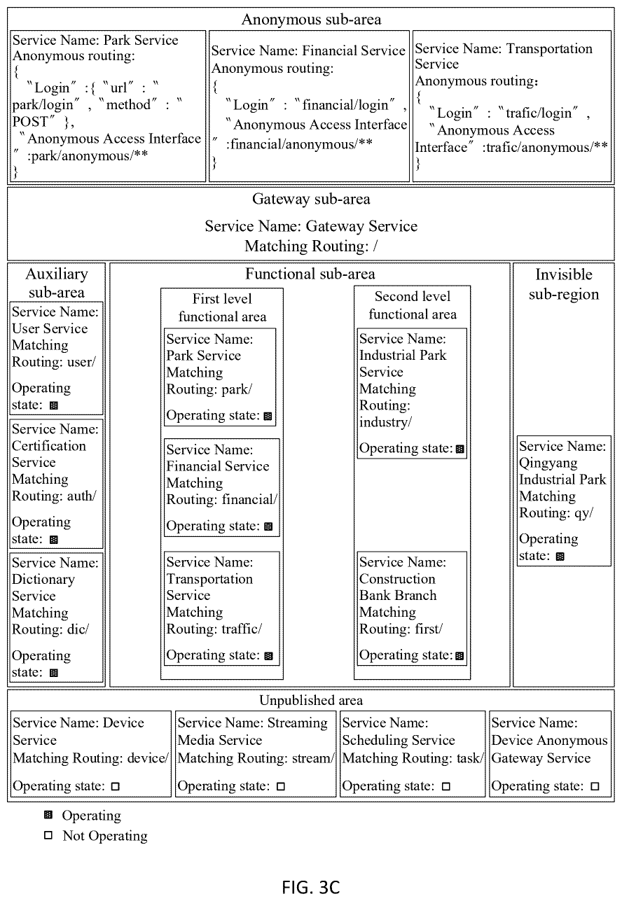

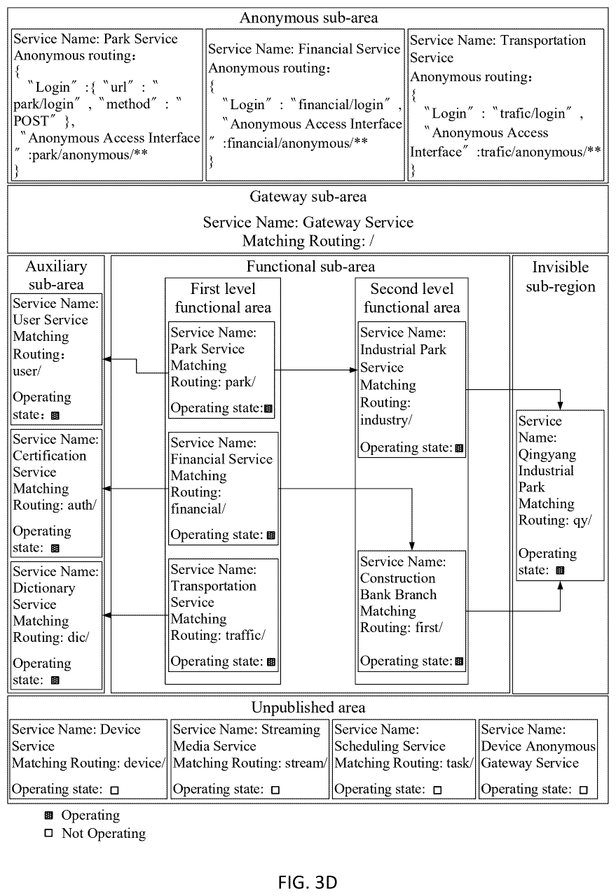

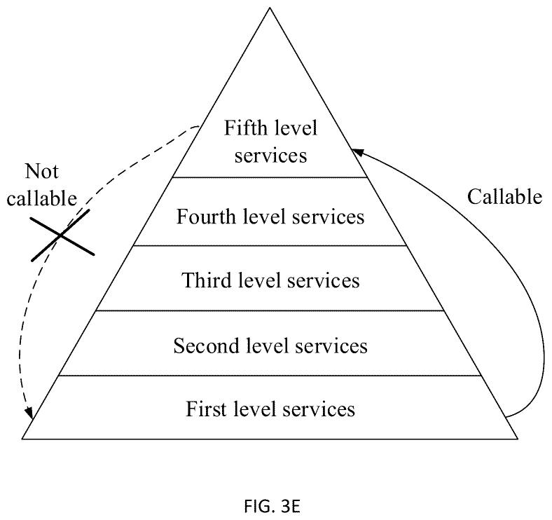

As shown in FIG. 3A to FIG. 3D, this embodiment also provides a gateway configuration management interface diagram, including the published area and the unpublished areas for displaying service modules in their respective areas. As shown in FIG. 3A, the published area includes multiple sub-areas, including the functional sub-area, the anonymous sub-area, the auxiliary sub-area, the invisible sub-area and the gateway sub-area. In implementation, the function sub-area is used to display the function service module; the anonymous sub-area is used to display the anonymous service module; the auxiliary sub-area is used to display the auxiliary service module; the invisible sub-area is used to display the invisible service module; the gateway sub-area is used to display the gateway service module.

As shown in FIG. 3B, the visual interface in this embodiment can also display the gateway configuration parameters of each service module, such as route matching data (matching route). “/park/” is used to access park services, and “/park/industry/” is used to access industrial park services. This can enable both data isolation and data interaction between functional services.

Optionally, this embodiment also provides a concept of service level, where the smaller the level of service, the lower the level of functional services, similar to a pyramid pattern, following a principle that upper level functional services cannot call lower level services, that is, those with higher levels cannot call those with lower levels, and those with lower levels can call those with higher levels. The level of services is determined based on the calling relationships between services, and the specific calling relationships can be determined based on the order of matching services in routing matching. As shown in FIG. 3E, this embodiment also provides a schematic diagram of a service level invocation, for example, services are divided into five levels, the first level, the second level, the third level, the fourth level, and the fifth level from bottom to top. The first level service can call the second, third, fourth, and fifth level services, the second level service can call the third, fourth, and fifth level services, the third level service can call the fourth and fifth level services, and the fourth level service can call the fifth level services.

As shown in FIG. 3B, in embodiments, two levels of areas displayed in the functional sub-area include the first level functional area and the second level functional area. The first level functional area is used to display the services of the first level, the second level functional area is used to display the services of the second level. The functional services of the first level functional area can call the data of the functional services of the second level functional area. However, the function service of the second level functional area cannot call the data of the function service of the first level functional area. Within the park service, the path starting with “/industry/” represents access to the data of the industrial park service, but within the industrial park service, the data of the park service cannot be accessed.

As shown in FIG. 3C, this embodiment can also display the operation states of each service module, so that users can understand the operation states of each service in the system, so as to reasonably allocate hardware resources and achieve load balancing. It should be noted that the display of operation states through squares in different colors in the figure is only an example. This embodiment can also represent different operation states based on different icon identifications, such as “good”, “normal”, “abnormal” and other icons, and can also directly display text to represent the operation states. Optionally, this embodiment can also use a chart/text to indicate whether the code calling in the system is normal or not, whether the library file reference is normal or not, and use Log/Map Table to map the chart/text.

As shown in FIG. 3D, this embodiment can also display the calling relationship between services corresponding to each service module, so that users can understand the flow of service data, realize a clear view of service data in the system, improve the operation and maintenance efficiency, and reduce the difficulty of operation and maintenance.

It should be noted that the calling relationship between the services corresponding to the two service modules in the embodiment specifically includes: the starting point of the calling relationship represents that the code executed is externally supported by the A module through the A interface/port; the end point of the calling represents that the code executed is supported by other modules and implemented by the interface/port of B. For example, the access path of A service is a, the access path of B service is b, and the access path of C service is c. If B service and C service are the lower level services of A service in the entire micro-service, such as A service in the first level, B service and C service in the second level, then the actual calling APIs for generating Service B and Service C are/a/b and/a/c, respectively. When the request path is/a/b/*, it will first access service A, then obtain data from service B according to the logical rules of service A, and finally return a response from service A. The same goes for accessing/a/c/*. This embodiment divides different services into different levels. First, it can meet the service needs. For example, when the current service is responding, it may require the data of service B in addition to the data of service A. Second, it can reduce the complexity of the system externally, reduce the visible services externally, and improve the horizontal expansion performance.

In some embodiments, the service module in the published area of the present embodiment includes a functional service module, the functional service module is used to provide a corresponding functional service for a user; the published area includes a functional sub-area, the functional sub-area is used to display the functional service module.

The levels of functional services corresponding to the functional service module are displayed; where the functional service modules corresponding to different levels of functional services are displayed in different functional areas within the functional sub-areas; in different levels, functional services of higher level can call functional services of lower level.

In the implementation, after receiving an access request, a level of a service is determined based on the order of the services routed to be matched in the routing matching rules, and similarly, the levels of different services are divided based on the order of the services routed to be matched in the routing matching rules. It should be noted that the calling relationship between the services in the present embodiment is determined based on the order of the matched services routed to be matched in the route matching rules. Among them, according to the route matching rules, the service that is matched first is a higher level service, and the services that are matched later are lower level services relative to the first service that is matched.

Step 201, in response to a user operation of dragging and dropping a target service module from the unpublished area to the published area, configuring a corresponding gateway for the target service module and operating a service corresponding to the target service module, where the target service module is selected by the user from service modules that are not operating in the unpublished area.

During the implementation, users can drag the service module from the unpublished area to the published area, so that the unpublished service module can be published. Users only need to drag the service module when publishing the service module, and the system will automatically configure the gateway for the service module to ensure the service module normal operation. When adding the service module, a mandatory item is included, which is to match the path (access path), and the path has certain rule restrictions, such as not including characters with other meanings in path matching, such as characters ‘/’, ‘*’, ‘?’ etc. After adding the service module, when associating the service module, it will automatically generate the route of the current service module based on upstream services and save it in the database. For example, when a Qingyang Industrial Park service (path=qy) is added, when deploying the service, the Qingyang Industrial Park service is linked under the industrial park service (the industrial park service path=industry, and there is no service on the upper level of the industrial park service). At this time, the real request path (path=/industry/qy) of Qingyang Industrial Park service will be automatically generated, thus realizing the automatic configuration of the gateway.

When the published area includes multiple sub-areas, including functional sub-areas, anonymous sub-areas, auxiliary sub-areas, invisible sub-areas, and gateway sub-areas, drag the target service module to the corresponding sub-area according to the sub-area to which the target service module belongs, in order to realize the automated gateway configuration of the target service module.

In some embodiments, the service module in embodiments includes any one or more types of the service module as follows.
(1) A functional service modules, representing functional services that provide functionality to the user.

In the implementation, the functional services are managed by gateway services, which can be customized by users to be added or deleted.

Each functional service can configure the required path PATH, flow restriction, request path processor, and fan-out of routing services (i.e. downstream functional services called) according to the needs of the service itself. The name of each functional service is separated by “/” in the entire PATH, and the accessed functional services are determined based on the maximum matching principle, where the maximum matching principle refers to determining the accessed functional services based on the path with the maximum matching degree.
(2) An anonymous service module, representing anonymous services that provide functionality for functional services, where the anonymous service does not require permission authentication when accessing functional services.

In the implementation, the anonymous service does not provide authenticated access, i.e., unrestricted access. The anonymous services themselves do not exist, but are a subsidiary service of functional services.

In the embodiments, no permission verification is required, which refers to certain APIs that can be accessed anonymously without the need for authentication. For example, when logging into an interface, authentication is not successful at this time, but user information needs to be requested to determine whether the current user can authenticate successfully. For example, some news platforms hope that all users can access all the news content on the platform, but they also want to avoid the complexity of user operations as much as possible. Therefore, the interface for obtaining news can be fully open, accessible to anyone, at any time, and under any circumstances, without restrictions.

It should be noted that since anonymous services are not a true service, they only provide anonymous access configuration for a certain functional service. Therefore, when adding anonymous services, users can only add them based on the added functional services in the current environment. Moreover, the prerequisite for the operation of anonymous services is that the functional services that the anonymous service depends on must be in an operating state.

In the implementation, Users can add corresponding anonymous service modules based on the functional service modules in the current visualization interface. One functional service module corresponds to one anonymous service module. If the functional service module corresponding to the added anonymous service module is in the published area, it indicates that the functional service module is in the operating state, and at this time, the anonymous service module can also operate. If the functional service module corresponding to the added anonymous service module is in the unpublished area, it indicates that the functional service module is in the non-operating state, and at this time, the anonymous service module cannot be operated.

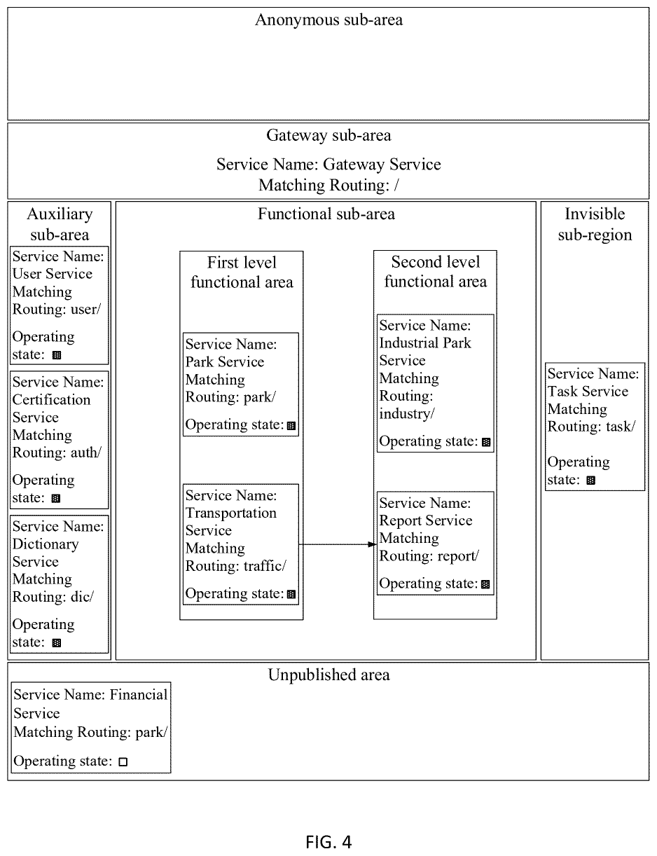

As shown in FIG. 4, this embodiment provides an anonymous gateway configuration interface diagram, in which, when adding anonymous services, only the anonymous services for “park service”, “equipment service”, “transportation service”, “report service” and “financial service” can be added, but the anonymous services added for “financial service” cannot be operated, because the financial services is in an non-operating state.

In implementation, only one anonymous service can be configured for the same function service, but multiple paths can be configured at the same time and the path must be an absolute path. Wildcard characters can be used (for example, “*” means that only one string can be followed, “/” is not allowed, and “** ” means unlimited), but from the perspective of data security, it is not recommended. For request methods, all request methods are available by default, that is, “*”. As shown in FIG. 3D, access that is the same as the “/park/login” path and the request method is “POST” does not require permission authentication. Access to the path starting with “/park/anonymous/” does not require permission authentication for any request.
(3) An auxiliary service module, representing auxiliary services that provide functionality for functional services; where the auxiliary services are non-essential for the functional services.

In implementation, the auxiliary services are managed by the gateway service, and users can add or delete them by themselves. The auxiliary services may not be perceived externally, but for functional services, once an internal relationship is formed between them, they can provide some necessary functions for functional services. As shown in FIG. 3D, even though the park service itself does not have user functions, since it needs the assistance of user services, the user services will indirectly provide the park service with user functions, and authentication services and financial services are the same. Auxiliary services can be accessed through the function service PATH and the auxiliary service PATH. For example, to access the user information of the park service, use “/park/user/”.
(4) An invisible service module, representing invisible services that provide functionality for functional services, wherein the invisible services are not visible to the public; it can be understood as for the user cannot access the service.

During the implementation, the invisible service is governed by the gateway service, and users can add or delete it to provide feature functions for the function service itself, which are invisible to the public, such as scheduled tasks, scheduling, messages, and other functions. As shown in FIG. 3D, Qingyang Industrial Park services are unreachable (inaccessible) through “/park/industry/qy/” or “/finical/first/qy/”. The invisible service is used to realize the functions that will be used by multiple functional services, which can avoid the repeated development of certain functions by multiple functional services. For example, when both the industrial park service and Construction Bank branch need to carry out the statistical identification of personnel flow, the timed task function of Qingyang Industrial Park service can support the statistical identification of personnel flow in a specific time period. For example, when both the industrial park service and the Construction Bank branch need to conduct timing video recording, the timing task and scheduling function of Qingyang Industrial Park service can support video recording for the industrial park service and the Construction Bank branch in a specific time period. The scheduling function is used to receive scheduling data and process it, and feedback the processing results to the industrial park service and the Construction Bank branch. Similarly, when both the industrial park service and Construction Bank branch need to send and receive messages, use the message function of Qingyang Industrial Park service to send and receive messages from the industrial park service and Construction Bank branch. The same sub functions in different functional services can be extracted through invisible services, and the invisible services can reduce the repeated execution of the same functions by different functional services.

The difference between invisible services and auxiliary services is that invisible services never provide functions to the public, whereas auxiliary services can provide specific functions when any of the functional services are connected to them.
(5) A gateway service module, representing the management of all services except for itself.

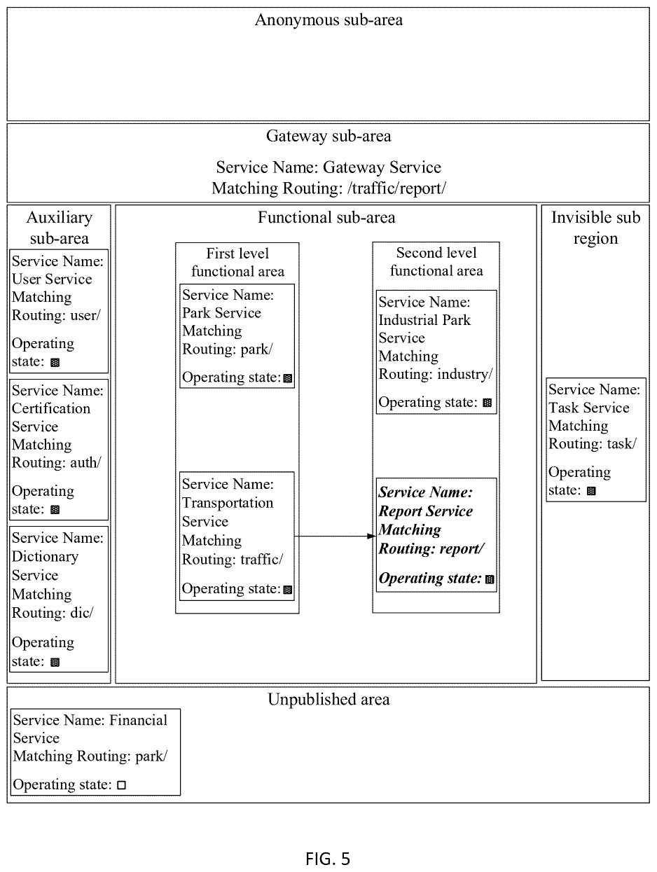

The gateway service in the embodiment is the cornerstone service of the entire system, which does not require users to manage, and provides management functions of all services (layout of the entire visual interface, basic data management functions of services, etc.), service request forwarding and returning (route matching), service states monitoring (real-time operation data such as operation states of each service under the system, connection states (network states) between services) and other related functions. As shown in FIG. 5, the embodiment provides an interface diagram of the route matching function. When a user selects a report service, it will automatically match the route to “/traffic/report/” according to the path of the selected service.

When the gateway service performs the basic data management function of the service, each service has a globally unique flag field, which is used to locate and forward the service in the path. As shown in FIG. 3D, the flag field of the park service is “park”, whose default access path is “/park/”, and the flag field of the industrial park is “industry”. However, as it is a secondary service of the park service, the default access path is “/park/industry/”. Therefore, based on the principle of maximum matching, it is easy to determine that the service accessed by the path “/park/industry/” is an industrial park service, and the level relationship between the entire project management services can be intuitively seen. This facilitates users to have a clearer understanding of the calling relationship between services and the flow of service data based on the level relationship between services, which is a function that form management does not have.

In some embodiments, there are unpublished services in the unpublished area. In the unpublished area, there are also unpublished services. The service module in the unpublished area corresponds to the initialization status of the user added service, which is simply a service data. The service itself may not exist. If the service itself does not exist, the corresponding service module can be successfully published. However, when the heartbeat between the service module and the service ontology is detected, the current service module, although in the published area, has stopped operating.

Throughout the whole visualization interface, the gateway service is the cornerstone service and must be in the operating state, if the gateway service is not operating, then the whole system is naturally in the down state. For the publishing and operation of the invisible service, the auxiliary service and the functional service, only when the gateway service itself is in the operating state, the other service modules can be published and operated successfully. The anonymous service is dependent on the functional service, and it can be published and operated successfully only when the corresponding functional service is in operating state.

In some embodiments, on the visualization interface, display at least one piece of information of the service name, service type, operating states, and gateway configuration parameters corresponding to the service module. The service type is determined based on the functions provided by the service. The operating states represent the load balancing states of the service.

Optionally, the gateway configuration parameters include at least one of route matching data (matching routes), and anonymous routes.

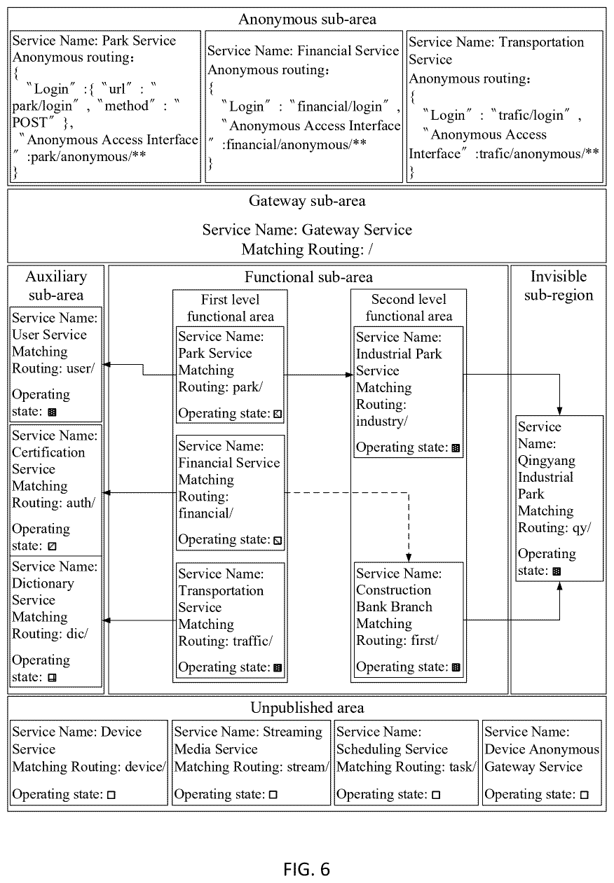

As shown in FIG. 6, the present embodiment provides a schematic diagram of services in a visualization interface. In the present embodiment, the visual interface displays service names, operating states, gateway configuration parameters (matching route, anonymous route), and the like of each service module. Different operating states are indicated by different colors, sub-areas for displaying different service types are indicated by different sub-area background colors, services of different service types are indicated by module colors of the service modules in the unpublished area. When the service is published, the colors of the service modules in the published area are unified to indicate that the service is online, and different network connection states are also indicated by different colors of the connecting lines.

In some embodiments, if the operation states of a service corresponding to the service module is displayed, different operation states are displayed in different modes, and the displayed operation states are used to prompt the user to carry out reasonable allocation of hardware resources.

The display mode of the operation state in the embodiment includes but is not limited to: icons, colors, text, etc., for example, different operation states can be expressed by icons of different colors.

In the implementation, different colors to indicate different operating states, it should be noted that, in the implementation, color representation of operating state is only an example. The user can customize the color of the different operating states or display mode, it is not limited in the embodiments. The methods used to distinguish the display of operating state based on this principle are within the scope of protection of the present disclosure.

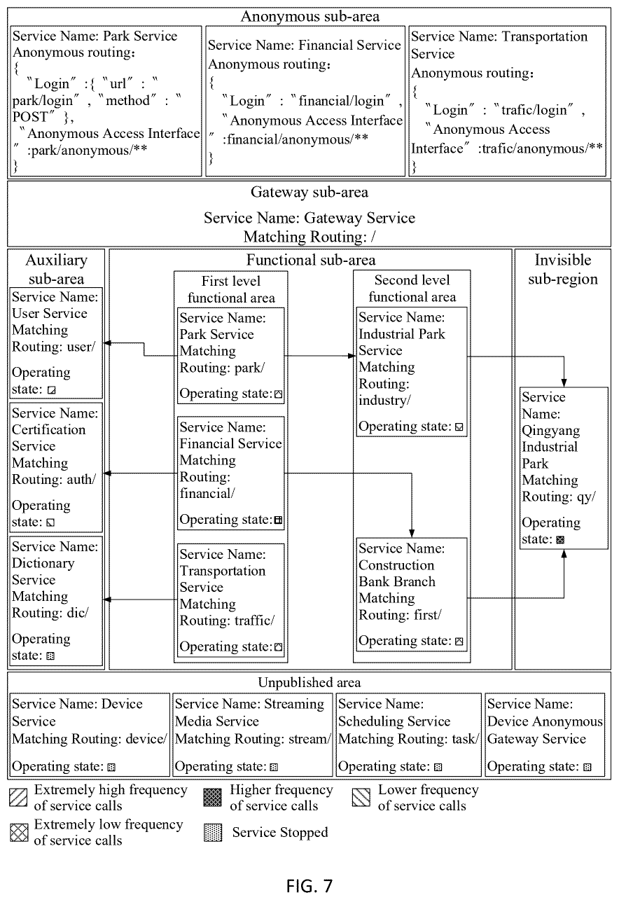

Optionally, as shown in FIG. 7, the present embodiment provides a gateway configuration interface graph displaying different operational states, the operational states in the embodiment including, but not limited to, any one or more of the following.

### (1) Unknown State

Use gray color to indicate the running status. The following situations may occur: one is the initialization status of newly added (from scratch) services, such as device services, one is the offline service (corresponding to the service module moving from the published area to the unpublished area), and the other is the service heartbeat stopping due to reasons such as service downtime and network unreachability, even though it is in the published area. For example, for dictionary services, it may be a malfunction of the service itself or a network connection disconnection between services, resulting in heartbeat detection failure. When the network connection is disconnected, the connection status between dictionary services and transportation services can be indicated by turning red.

### (2) First Level Frequency Request Service

Use blue color to indicate operational state, indicating low request service, that is, the frequency of service calls is extremely low. It is possible to streamline resources and reduce operating costs for this service, such as park services, industrial park services, transportation services, and Construction Bank branch services.

### (3) Second Level Frequency Request Service

Use green color to indicate operational states, indicating normal service requests. The frequency of service requests is moderate, and the service configuration is reasonable, such as authentication services.

### (4) Third Level Frequency Request Service

Use yellow color to indicate the operational states, which means that the frequency of requests is high and the service configuration is reasonable, such as financial services.

### (5) Fourth level frequency request service.

Use orange color to indicate the operation states, which means that the request frequency is high and the service configuration is not reasonable, such as the Qingyang Industrial Park service.

### (6) Fifth Level Frequency Request Service

Use red color to indicate the operational states, which means that the request frequency is extremely high and the service configuration is not reasonable, such as the user service.

The higher the frequency level, the higher the frequency of requests.

Optionally, the present embodiment may indicate different operating states by different color blocks displayed, and the color of the color blocks is used to indicate the invocation frequency of the services corresponding to the service module, and different color blocks indicate different invocation frequencies.

By using color blocks to visually display the call frequency of corresponding service of each service module, users can easily understand the high and low request frequency, adjust the architecture in real-time, adjust bandwidth usage, and lock in target customers with high service demands.

In some embodiments, the calling relationship between the service modules is indicated by means of the connecting lines between the service modules, and the connection state between a service of the target service module and a corresponding service of the service module in the published area may also be indicated by means of the display mode of the connecting lines; where the connecting lines of different display modes indicate different connection states.

The display modes of the connecting lines in this embodiment include, but are not limited to, colors, line types, thicknesses, etc., and different connecting states are distinguished by at least one of different colors, line types, thicknesses, and so on.

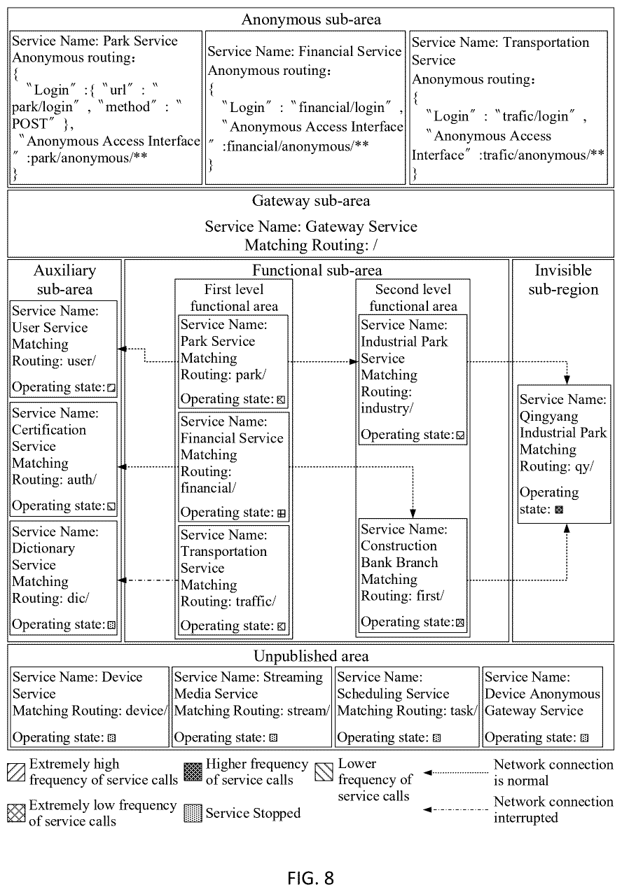

Optionally, different connection states can be indicated by connecting lines of different colors, as shown in FIG. 8. The present implementation provides a gateway configuration interface that displays a connection state, and the connecting lines between a service module and a service module have the following three colors.

The gray line indicates that when the service moves from the unpublished area to the published area, the connection with the superior service has been established, but the network is not connected temporarily (heartbeat detection is not established).

The green line indicates a normal connection between services, the network is operating normally, e.g., the connecting line between a park service and an industrial park service.

The red line indicates the network outage between services, such as the connecting line between a transportation service and a dictionary service, but this may occur because the network is good but the heartbeat between services is interrupted.

In the implementation, the form of judging the operation states according to the color, can let the user intuitively understand the operation states of each service in the whole system, according to the actual needs of the reasonable allocation of hardware resources, so that the whole system is operating in a more reasonable interval, improve the operating efficiency of the system. On the other hand, it allows users to quickly determine the abnormalities of the service operation of the whole system. Even if you cannot accurately locate, but at least the fault can be limited to a range, greatly reducing the fault troubleshooting time, reducing the time of service anomalies, increasing the stability of the overall operation of the system.

In some embodiments, the display mode of the published area and the display mode of the unpublished area are different.

The display mode of a service module in the unpublished area is determined according to the service type of the service module, and service modules of different service types are displayed differently in the unpublished area.

Optionally, the display mode of the area in the embodiment can be distinguished by different background colors of the area, or by different text contents, or by different icons, and the embodiment does not make too many limitations in this regard.

Optionally, the display mode of the service module of the unpublished area in the embodiment can be distinguished by different module colors, different module themes, and different icons, and the embodiment does not make too many limitations in this regard. Optionally, the module colors of the service modules in the unpublished area are different according to the types of service, and the module colors of the service modules in the published area can be set to the same color or a different color, and when the service module is moved from the unpublished area to the published area, the color of the service module can be changed or not, and the embodiment does not make too many limitations in this regard.

In some embodiments, the published area includes a plurality of sub-areas, one sub-area is used to display service modules of the same service type; different sub-areas are used to display service modules of different service types; and the display modes of different sub-areas are different.

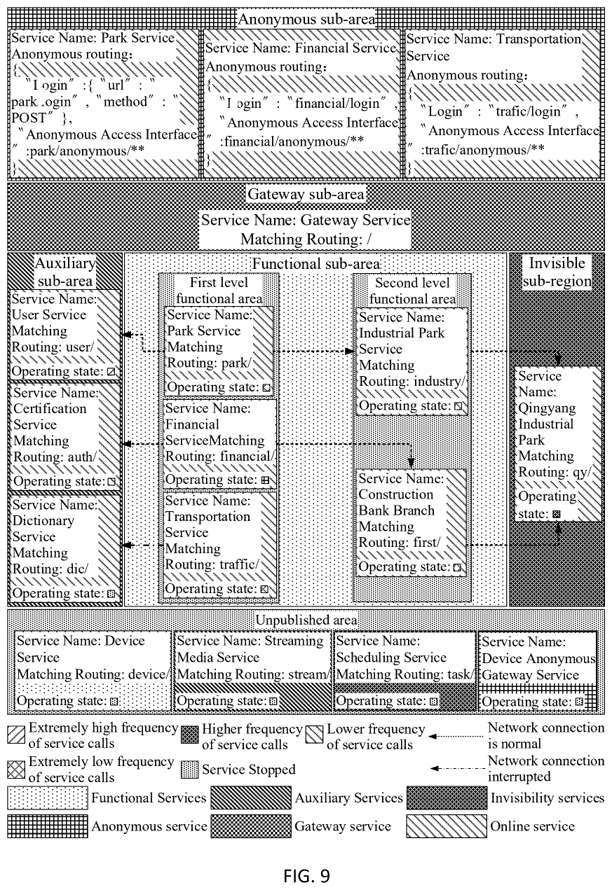

In the implementation, different sub-areas have different background colors, and the background color of each sub-area and the module color of the service module in the sub-area may be the same or different, and the embodiment does not make too many limitations in this regard. As shown in FIG. 9, the embodiment provides a gateway configuration interface corresponding to the colors of the sub-areas and the service modules, for example, blue indicates a functional sub-area and a functional service; purple indicates an auxiliary sub-area and an auxiliary service; orange indicates an invisible sub-area and an invisible service; yellow indicates an anonymous sub-area and an anonymous service; red indicates a gateway sub-area and a gateway service; and green indicates an on-line service. When the service has been added and is in the unpublished area, by using the module colors of the service module, it is possible to distinguish which sub-area the service module belongs to, such as device services belonging to functional services and scheduling services belonging to invisible services. When the service is published, the color of the service module becomes green, indicating that the service is an online service.

In the embodiment, the visualization interface is used to express the calling relationship and level relationship between the services through visualization, which makes the relationship between the services in the whole system clear to the user, and can improve the efficiency of system maintenance.

In some embodiments, the following steps may also be performed before the visualization interface displays the service module.

In response to a user's custom configuration operation of the visualization interface, at least one of a number of areas, a name of an area, a location of an area, a display mode of an area, a size of an area, a service module displayed in an area, and a service type of a service module displayed in an area in the visualization interface is configured accordingly.

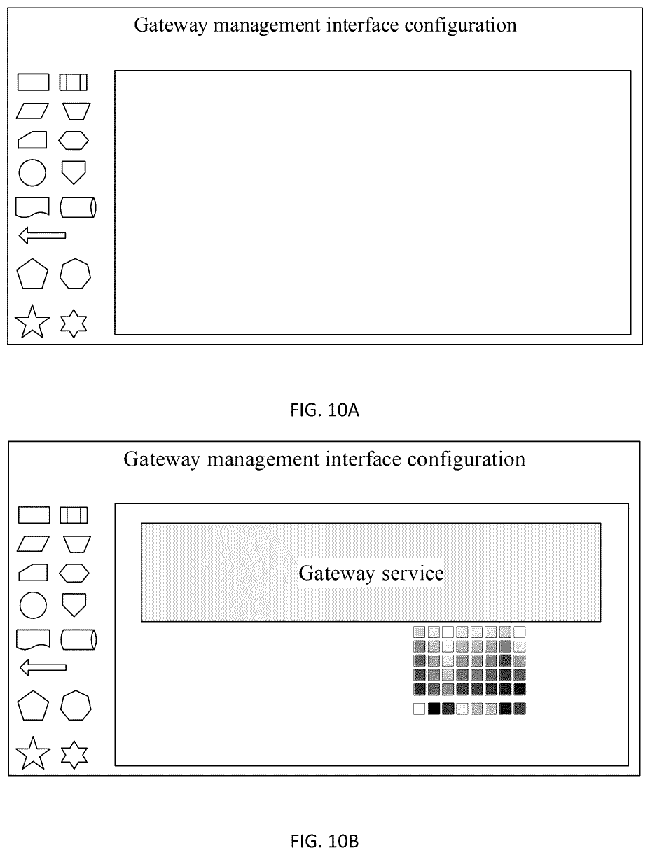

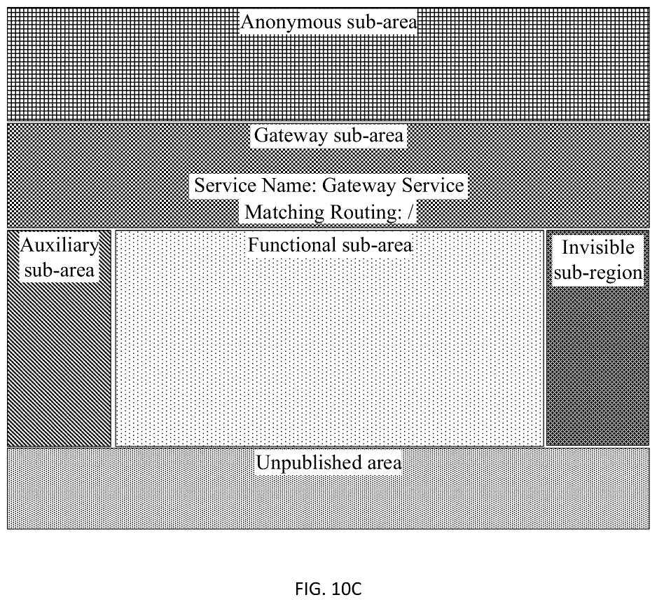

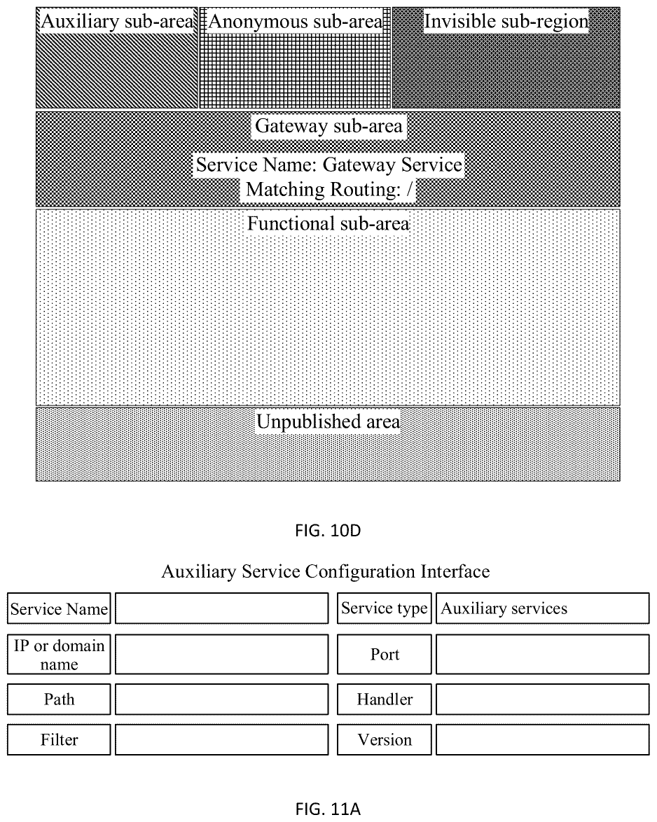

In the implementation, the user can set the overall layout of the visual interface, including customized design of each area and sub-area, for example, the shape, position, color and other functions of each area can be customized, as shown in FIG. 10A to FIG. 10B. The embodiment also provides an initial configuration diagram of the gateway management interface. The user can drag the prefabricated pattern on the left to the editing area on the right to customize the configuration of each area, including area shape, color, name, location, size and other information. After user configuration is completed, as shown in FIG. 10C to FIG. 10D, the embodiment also provides an example diagram of gateway interface configuration.

When the configuration of the gateway interface is completed, only the gateway service is active in the whole system, at this time the user can add the required services to the system in the visualization interface.

In some embodiments, a service configuration interface is displayed in response to a service addition operation by a user in a visualization interface, and the service configuration interface is used to display a plurality of indicators of the service.

In response to user input of indicator parameters for multiple indicators, a service module is generated and displayed in the unpublished area.

In some embodiments, the indicator parameter includes service types, and one service type corresponds to one display mode. According to the display mode corresponding to the service type in the indicator parameter input by the user, the service module is displayed in the unpublished area according to the display mode corresponding to the service type.

In the implementation, the present embodiment can define different colors for service modules of different service types to distinguish them, and can also define each sub-area in the published area to display service modules of different service types. It can also be defined that the background color of the sub-area displaying a service type is the same as the module color of the service type. This facilitates users to drag the service module to the same colored sub-area based on the color of the service module when launching the service module.

In some embodiments, the service configuration interface is displayed in the following manner.

In response to a service addition operation of a user in a visualization interface, displaying a service configuration interface according to a service type of a service corresponding to the service addition operation.

AT least one of the multiple indicators displayed in the service configuration interface corresponding to the different service types is different.

Optionally, the user may trigger a service addition operation in the unpublished area, for example, an add button is displayed in the unpublished area, and the user clicks on the add button to trigger entry into the service configuration interface. Optionally, for example, the user clicks on the unpublished area (including a double-click, a right-click, and a left-click, etc.), triggering entry into the service configuration interface. The embodiment does not overly limit how to perform the specific service addition operation.

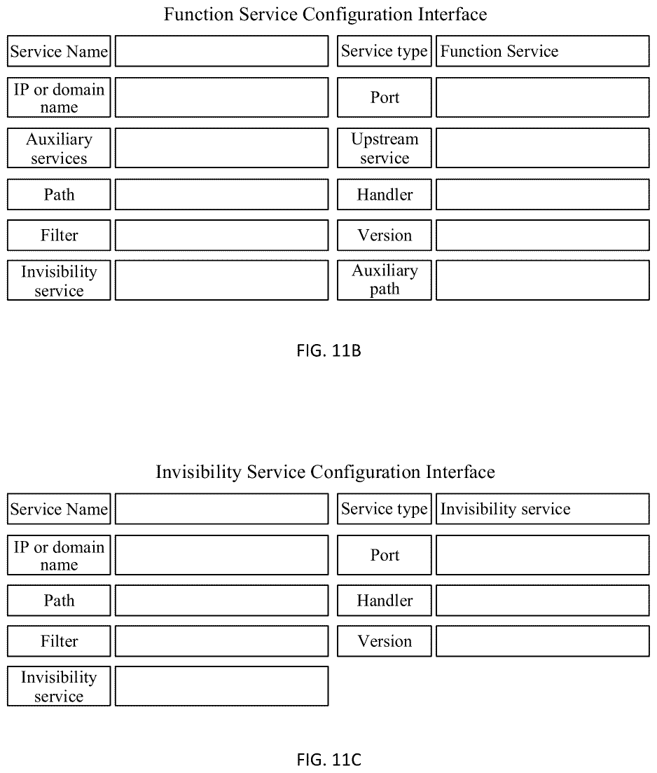

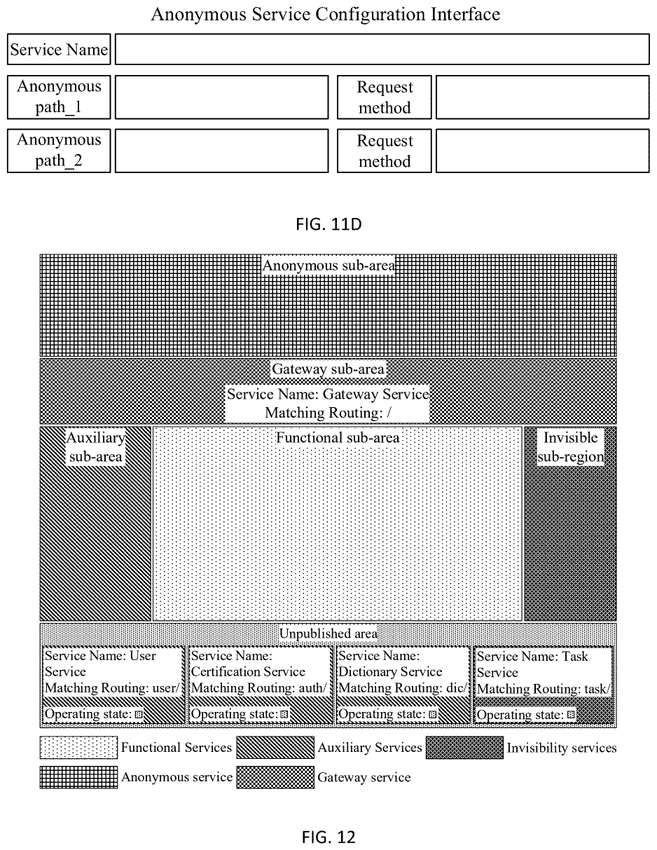

As shown in FIG. 11A, the embodiment provides a schematic diagram of the auxiliary service configuration interface. The user can configure various indicators and enter indicator parameters in the corresponding indicator column. For example, when configuring auxiliary services, the service name, service type, IP or domain name, port, path, handler, filter, and version can be configured.

As shown in FIG. 11B, the embodiment provides a schematic diagram of the function service configuration interface. The user can configure various indicators and input indicator parameters in the corresponding indicator column. For example, when configuring the function service, the service name, service type, IP or domain name, port, auxiliary service, upstream service, path, handler, filter, version, invisible service and auxiliary path can be configured.

As shown in FIG. 11C, this embodiment provides a schematic diagram of an invisible service configuration interface. The user can configure various indicators and enter indicator parameters in the corresponding indicator column. For example, when configuring the invisible service, the service name, service type, IP or domain name, port, path, handler, filter, version, and invisible service can be configured.

As shown in FIG. 11D, this embodiment provides a schematic diagram of an anonymous service configuration interface. The user can configure various indicators and enter indicator parameters in the corresponding indicator column. For example, when configuring anonymous services, the service name, anonymous path PATH_1 and the corresponding request method, anonymous path PATH_2 and the corresponding request method can be configured.

In some embodiments, the indicator in this embodiment includes any one or more of:
service names; service types; IP or domain names; ports; paths; handler; filter; edition; ancillary services; upstream services; downstream services; invisible services; auxiliary paths; anonymous paths; request modes.

The following is a description of each of these indicators.

Service Name: users can customize the name and automatically generate the final name according to the rule (service name_Version). The final name generated has global uniqueness in the system, such as parkservice_v_1.0.

Service types: including but not limited to gateway services (as a fixed value option, users do not need to configure), anonymous services, auxiliary services, functional services and invisible services. In order to facilitate the user to have intuitive judgment of the service type, different service types of the service module in the configuration is completed, the color states displayed in the visual interface are not the same, the specific color will be determined based on the color of the service type published on the current visualization interface.

Auxiliary services: a specific configuration option for function services. The auxiliary services that have been added to the current system can be selected from the drop-down list. 0, 1 or more auxiliary services can be configured. After configuring auxiliary services, whether to configure auxiliary paths can be selected. For example, the auxiliary services that the park service rely on include user services and authentication services, transportation services rely on dictionary services, and financial services do not rely on any auxiliary services.

Upstream service: a specific configuration option for function services. The auxiliary services that have been added to the current system can be selected from the drop-down list. 0, 1 or more upstream services can be configured. If the upstream service does not exist, the default upstream service is the gateway service. If multiple upstream services are configured, the levels of the multiple upstream services are calculated by the maximum level of the upstream functional services (see the introduction to the levels). If the upstream service of industrial park service is park service, the upstream service of park service is gateway service.

Path: the path specified by the service is unique in the whole system, but the special character “/” cannot be specified because it is the default value of the gateway service system. This value will automatically generate hidden information, the requested url_match_pattern, the rule is “url_match_pattern of upstream service+path+/of the service”. For example, the path of the park service is “park”, while the url_match_pattern is “/park/”, and the “path” of the industrial park service is “industry”. Since the upstream function service of the industrial park service is the park service, the url_match_pattern of the industrial park service is “/park/industry/”.

Auxiliary path: a specific configuration option for function services. According to the configured auxiliary service, specify the pattern to be forwarded to the auxiliary service. If the auxiliary path is not configured, the url pattern used when querying auxiliary service data is url_match_pattern of the current service and url_match_pattern of the auxiliary service. If the auxiliary path is configured, the configured auxiliary path will be used to forward the request directly. Take the park service (path “park”) as an example. If the auxiliary path is not configured, the url pattern of the data request for the user service (path “user”) is/park/user/. If the auxiliary path is configured as/sys-user, the url pattern of the data request for the user service is /park/sys-user/.

FILTER and HANDLER: they represent filters and interceptors respectively, encapsulating public operations. 0, 1 or more filters or handlers can be configured according to services need. This indicator can be understood as an invisible service, but it is different from the invisible service in that the invisible service is the operation after the successful request for the functional service, while this indicator is the operation before the request for the functional service. For the configured service itself, it is global, that is, these two operations need to be executed for each request for the function service.

Invisible services: it is the specific configuration options for the functional service and the invisible services. According to service needs can be configured 0, 1 or more, itself does not have the functions used by the user, but mainly provides support for functional services and encapsulates common operations. Take the scheduling service as an example, the functional service can hand over all the scheduling tasks to it for execution, while the functional service itself does not need to carry out the development of scheduling tasks.

It should be noted that the upstream service and the upstream functional service in this embodiment have the same meaning, and both of which are services that can call other services.

As shown in FIG. 12, this embodiment provides a visualization interface after the addition of auxiliary services and invisible services is completed, in which the user service, the authentication service, and the dictionary service are determined to be auxiliary services by the background color of the auxiliary sub-area, and the task service is determined to be an invisible service according to the background color of the invisible sub-area, and the service module is displayed in the unpublished area after the user adds the services, and each service module color and the background color of the corresponding sub-area are the same.

This embodiment can display the publishing of services by dragging and dropping the service module, when the service is added, it will form the service modules (component), the service module itself and the related configuration is visible to the user, but the real internal processing flow, the user does not need to care about. Users can put services online (i.e., publishing, from the unpublished area to the published area) and offline (from the published area to the unpublished area) by dragging and dropping service modules.

In some embodiments, in response to a user's operation of dragging and dropping a target service module from an unpublished area to a published area, a latching principle may also be incorporated, as follows:
activating, based on the service type of the target service module, a sub-area of the published area with the same service type as the service type, for prompting a user to drag and drop the target service module to the activated sub-area.

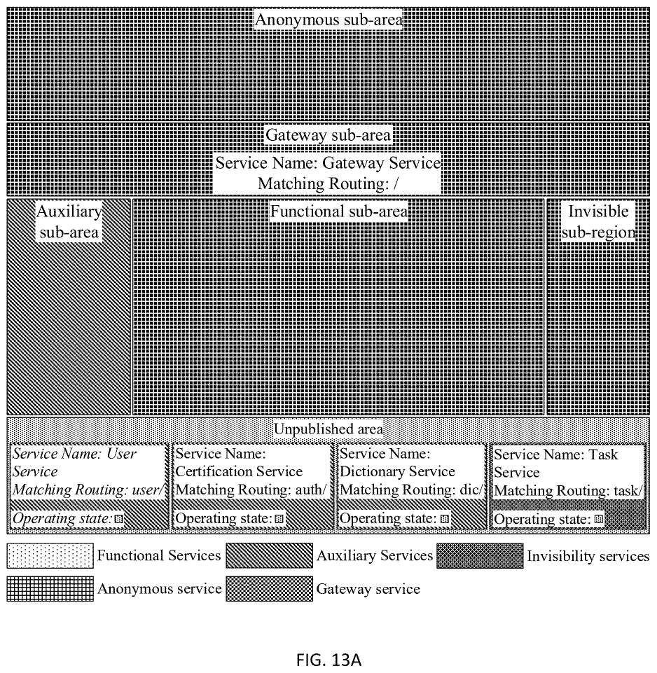

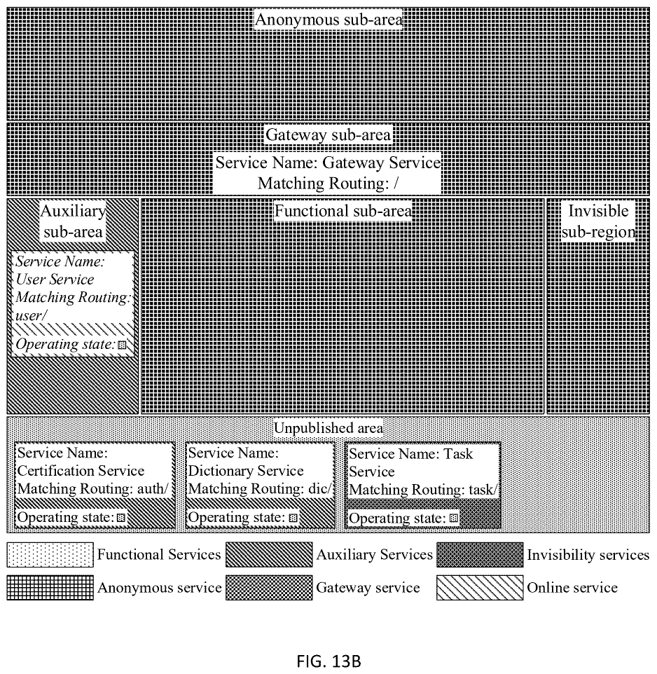

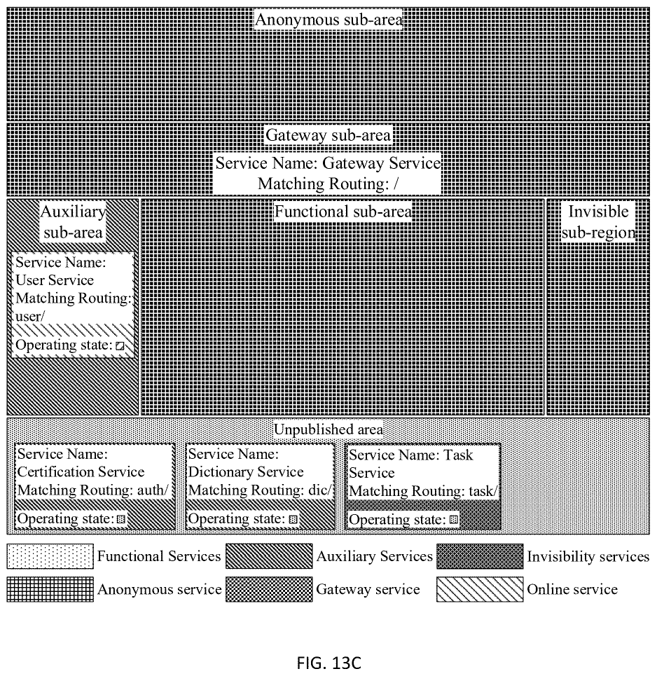

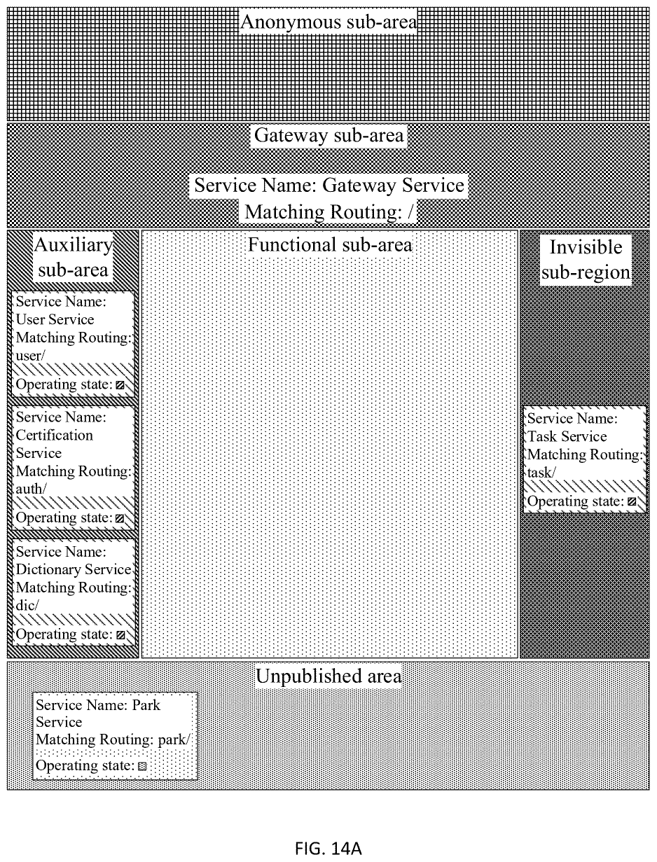

In the implementation, as shown in FIGS. 13A to 13B, the embodiment provides a schematic diagram of service publishing. When a user selects the service modules of different service types, only the sub-areas of the corresponding service type are activated, that is, the service module can only be moved between each sub-area of the same service type in the published area and the unpublished area. For example, when the user selects the user service module, only the auxiliary sub-area is activated, and the user can only move the user service module to the auxiliary sub-area. As shown in FIG. 13C, this embodiment provides an interface after the service is published and runs normally. When the service publishing runs normally, the color of the service module can be changed to distinguish it from the background color of the sub-area.

In some embodiments, after the service is published, the gateway configuration will be performed automatically in the background, with the following steps:
configuring corresponding gateway configuration parameters for the target service module according to the calling relationship between the target service module and a service module in the published area.

Optionally, the gateway configuration parameters in this embodiment include, but are not limited to, the route matching data, the anonymous routing data, and the like.

In some embodiments, the calling relationship between the target service module and the service module in the published area is determined based on any one of the following modes:
Mode 1, determining the calling relationship between the target service module and the service module in the published area based on an upstream service and/or a downstream service in an indicator parameter of the target service module;
where the upstream service is used to call a service corresponding to the target service module, and the downstream service is used to be called by a service corresponding to the target service module.

Optionally, the target service module and the service module with a calling relationship are connected by a connecting line to display the calling relationship.

Optionally, a directional identifier may also be displayed on the connecting line, the directional identifier is used to indicate the flow direction of service data of the service module in the calling relationship.

In some embodiments, after displaying a directional identifier on the connecting line, the directional identifier indicates that the service data is transferred from the target service module to the first service module. It is also possible to change the calling relationship between the service modules by manually dragging and dropping the directional identifier on the connecting line, as follows.

In response to a user operation of dragging and dropping the directional indicator to point to a second service module, updating a calling relationship between the target service module and the first service module, to a calling relationship between the target service module and the second service module.

In the implementation, the directional identifier is an arrow, for example, which is pointed from the target service module to the first service module, and the user can modify the service module which has a calling relationship with the target service module by dragging and dropping the arrow to update the calling relationship to the calling relationship between the target service module and the second service module.

Mode 2, in response to a manual connection operation by a user of the target service module and the service module in the published area, determining the calling relationship between the target service module and the service module in the published area.

In some embodiments, displaying a connecting line corresponding to the manual connecting operation; determining a direction of the connecting line based on the start and end points of the manual connecting operation, and displaying the direction by means of a directional indicator. The directional identifier is used to represent the flow direction of service data of the service module in the calling relationship.

Optionally, the directional identifier in this embodiment include, but are not limited to, arrows or other directional identifier, icons, etc., and this embodiment is not overly limited in this regard.

In some embodiments, after displaying the directional identifier on the manual connecting line, the directional identifier indicates that the service data is transferred from the target service module to the first service module, and it is also possible to change the calling relationship between the service modules by manually dragging and dropping the directional identifier on the connecting line, as follows.

In response to a user operation of dragging and dropping the directional indicator to point to a second service module, updating a calling relationship between the target service module and the first service module, to a calling relationship between the target service module and the second service module.

In the implementation, the directional identifier is an arrow, for example, when a user hand draws a line and displays an arrow at the end of the line, this arrow points from the target service module to the first service module. The user can modify a service module having a calling relationship with the target service module by dragging and dropping the arrow to update the calling relationship to the calling relationship between the target service module and the second service module.

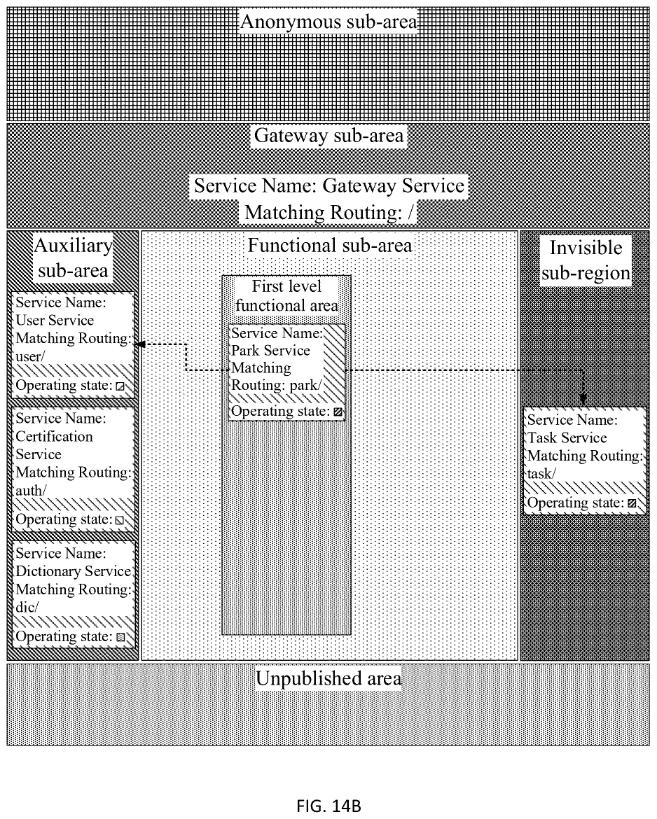

In the implementation, take adding functional services with auxiliary services and invisible services as an example, as shown in FIG. 14A, this embodiment provides an interface for adding functional services. The interface has currently added park services, and runs auxiliary services and invisible services. Based on the auxiliary services and stealth services that the park service itself will call, users drag and drop the park service module to the functional sub area. As shown in FIG. 14B, an interface after service publishing is completed, the system will automatically connect the called user services and task services according to the call relationship of the park service. The connecting line and arrow represent the call relationship between different services. After the park service is published, the system will automatically connect auxiliary services and invisible services according to the service information. When a function service with levels is launched, only the superior function service of the function service can be automatically connected, and the subordinate function service of the function service can be manually connected.

It should be noted that the calling relationship in this implementation also includes the level relationship between different functional services. In the implementation, after the service publishing is completed, the background will automatically add the relevant route matching data according to the calling relationship between the services and the level relationships, in order to determine the flow of data during service usage. At the same time, when the service goes offline, it will also delete the corresponding routing matching data to avoid causing data errors or the problem of going without returning.

In some embodiments, when there is a level relationship between functional services, after the completion of the drag and drop publishing, it will automatically adaptively match the level where the current service is located according to the upstream service of the current service. If the upstream service does not exist, it will be automatically published to the first level of the service, if it exists, then it will be adaptive according to the maximum level of the upstream service and associate the connection operation between the upstream service and the current service. But if there is a downstream service, then the user can only manually connect to the service.

It should be noted that, in this embodiment, the upstream service in the functional sub-area is defined as an upstream functional service, and the downstream service in the functional sub-area is defined as a downstream functional service. In actually, the meaning of the upstream service and the upstream functional service is the same, and the meaning of the downstream service and the downstream functional service is the same.

The first scenario is the level adjustment after the launch of functional services.

In some embodiments, in response to a user's operation of dragging and dropping a target service module from an unpublished area to the functional sub-area, a level of functional services corresponding to a functional service module in the functional sub-area is adaptively adjusted; where the target service module is a functional service module in the unpublished area.

In the implementation, the user drags and drops unpublished functional service modules from the unpublished area to the functional sub-area, and if there is a level relationship between multiple functional service modules in the functional sub-area, the levels of the functional service modules in the dragged and dropped functional sub-area will be adjusted adaptively.

In some embodiments, the levels of functional services corresponding to functional service modules in the functional sub-area are adaptively adjusted by the following steps:
adaptively adjusting the levels of the functional services corresponding to the functional service module according to whether or not an upstream functional service exists for the functional service corresponding to the functional service module, and a maximum level of the upstream functional service when the upstream functional service exists; where the upstream functional service is used to call the functional service corresponding to the functional service module.

In some embodiments, the levels of functional services corresponding to the functional service module are adaptively adjusted by the following steps:
determining that the level of the functional service corresponding to the functional service module is the maximum level, in a case that the functional service corresponding to the functional service module does not have upstream functional services; or
determining a level of the functional service corresponding to the functional service module according to a maximum level of the upstream functional service, in a case that there are upstream functional services for the functional service corresponding to the functional service module.

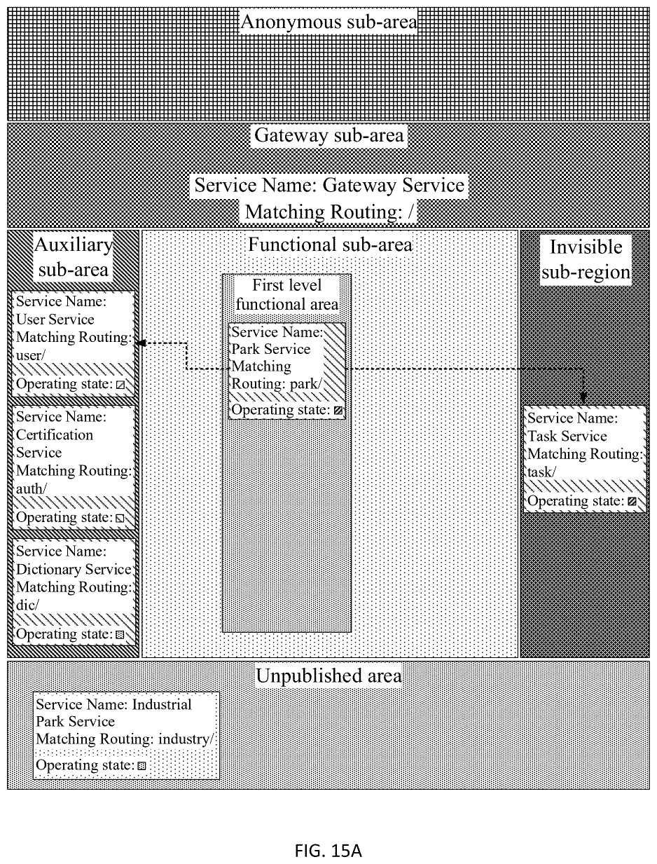

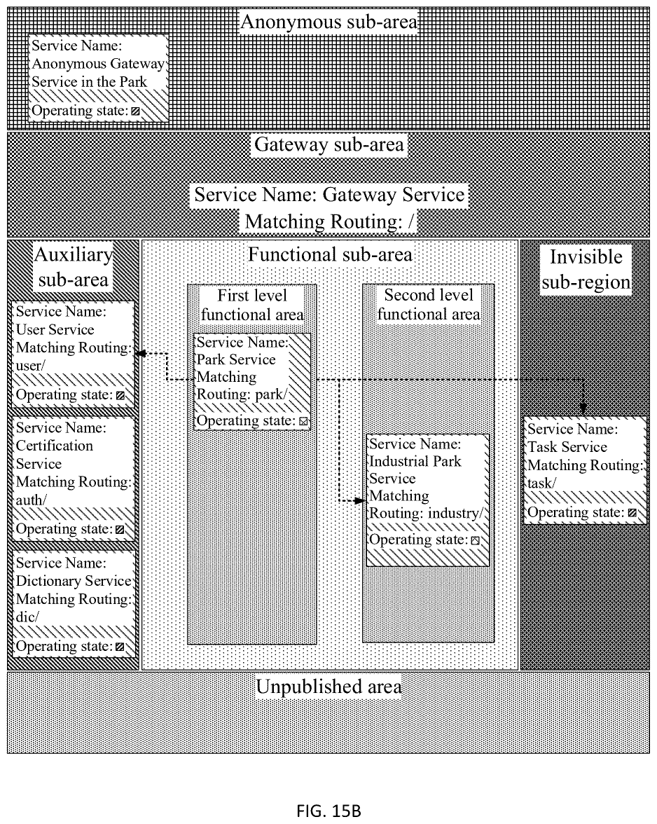

As shown in FIG. 15A to FIG. 15B, this embodiment provides a level adjustment interface diagram after the functional services are launched. When users drag the industrial park service module from the unpublished area to the functional sub-area, since the upstream functional service (i.e. superior functional services) of the industrial park service is the park service, and the park service is at the first level, the industrial park service is at the second level. The industrial park service is set as the second level functional area adaptively. The number of functional areas included in functional sub-areas is determined according to the level structure of current functional services, and is updated in real time. During the implementation, it can be seen from the interface changes after the service is launched, the system automatically places the industrial park service at the second level and completes the network connection between it and the higher-level functional service (upstream functional service), such as the park service.

The second scenario is the level adjustment after functional services are taken offline.

In some embodiments, in response to a user operation of dragging and dropping a specified service module from the functional sub-area to the unpublished area, the levels of functional services corresponding to the functional service module in the functional sub-area are adaptively adjusted; the specified service module is selected by the user from the functional service modules in the functional sub-area.

In the implementation, after users drag and drop the functional service modules in the functional sub-area to the unpublished area, the functional sub-area will adaptively adjust the level of each functional service module according to the level relationship between the remaining functional service modules.

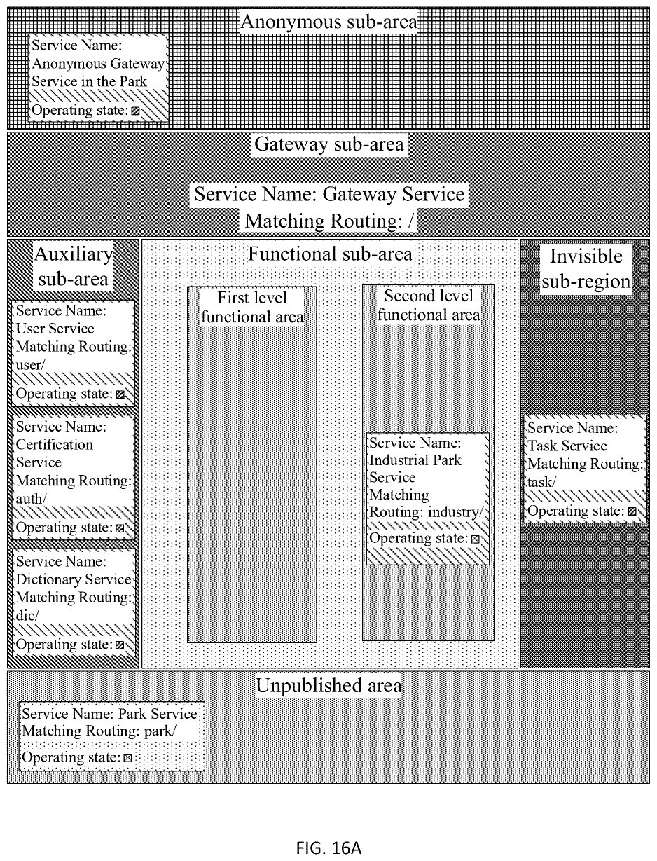

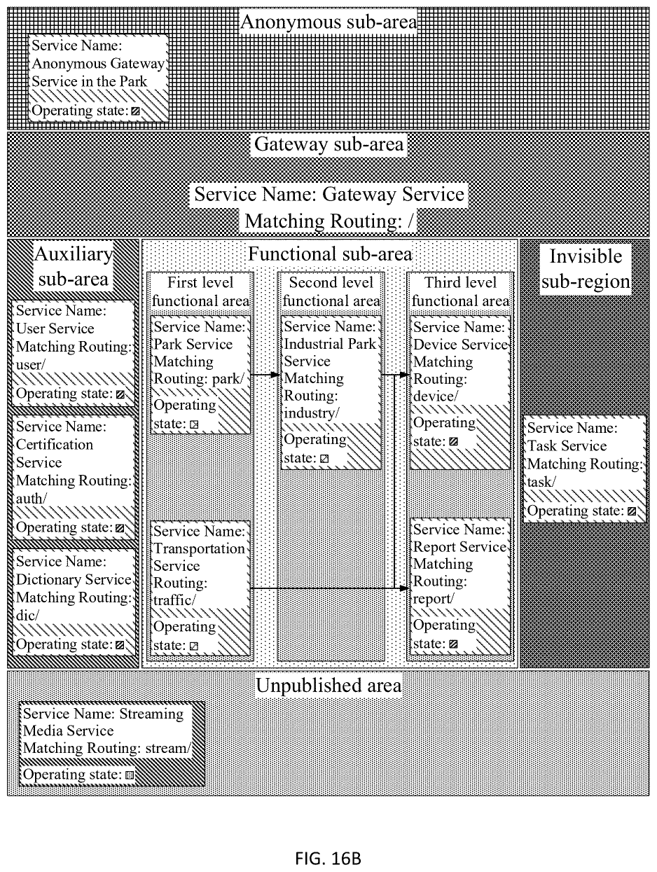

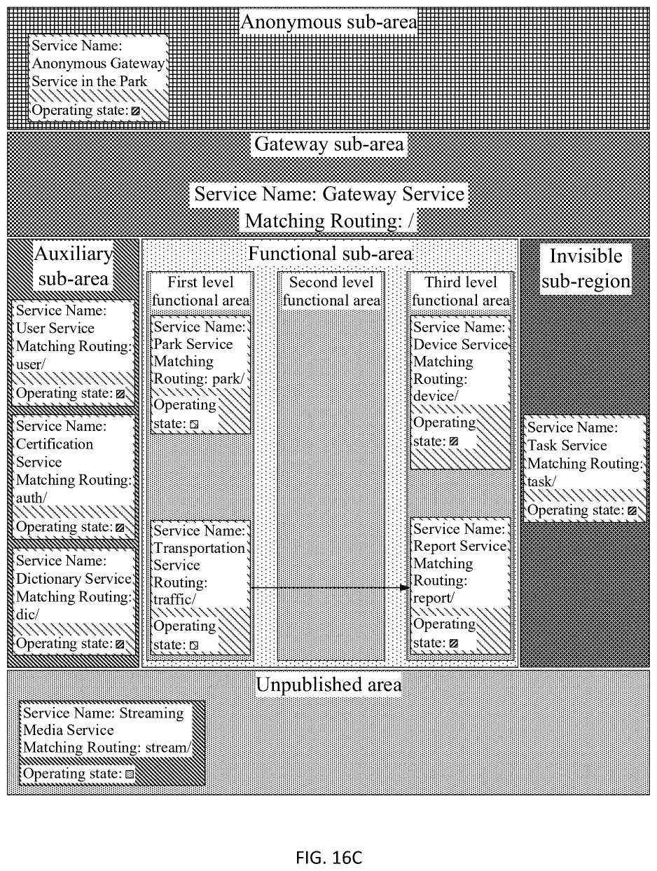

It should be noted that when functional services with level relationships are taken offline, service islands may form in functional sub areas, resulting in unreachable services. As shown in FIG. 16A, this embodiment provides a service interface formed by offline service. When the park service in the functional sub area is offline, the industrial park service will form an independent island service, resulting in unreachable services.

If it is an intermediate level service offline, then all associated lower level services are inaccessible. As shown in FIG. 16B, the interface diagram of a multi-level service module provided in this embodiment can be accessed in the initial state through “/park/industry/device/” and “/park/industry/report/” respectively for device services and report services, and “/traffic/report/” for report services. However, when the industrial park service is deleted, as shown in FIG. 16C, the interface diagram of a service offline provided in this embodiment forms an island of device service with no service access. The previous “/park/industry/report/” cannot access the report service, but “/traffic/report/” can still access the report service normally.

In some embodiments, the present embodiment may also, in response to a user operation of dragging and dropping a specified service module to the unpublished area, control service corresponding to the specified service module to be converted from an operational state to an inoperational state, and delete a gateway configuration parameter corresponding to the specified service module;
where the specified service module is selected by the user from the service modules in the published area.

In the implementation, after the user drags and drops the service module from the published area to the unpublished area, the service corresponding to the service module goes offline, and then the system automatically deletes the gateway configuration parameters corresponding to the service module, such as the route matching data.

In some embodiments, the present embodiment may also, delete configuration data corresponding to the service module in response to a deletion operation of a service module in the unpublished area by a user, where the configuration data includes gateway configuration parameters. The configuration data can also include indicator parameters related the services, such as service name, service type, and other indicator parameters.

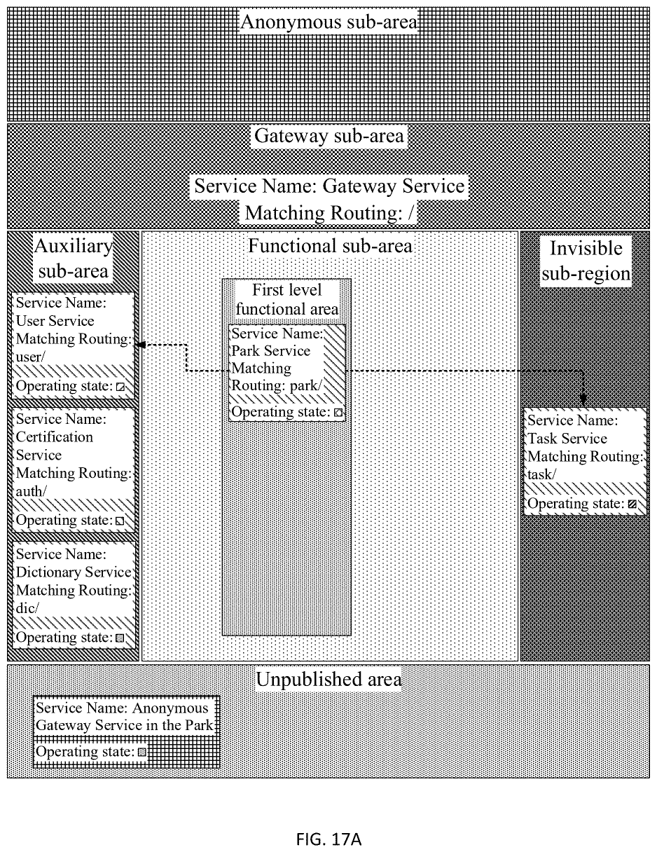

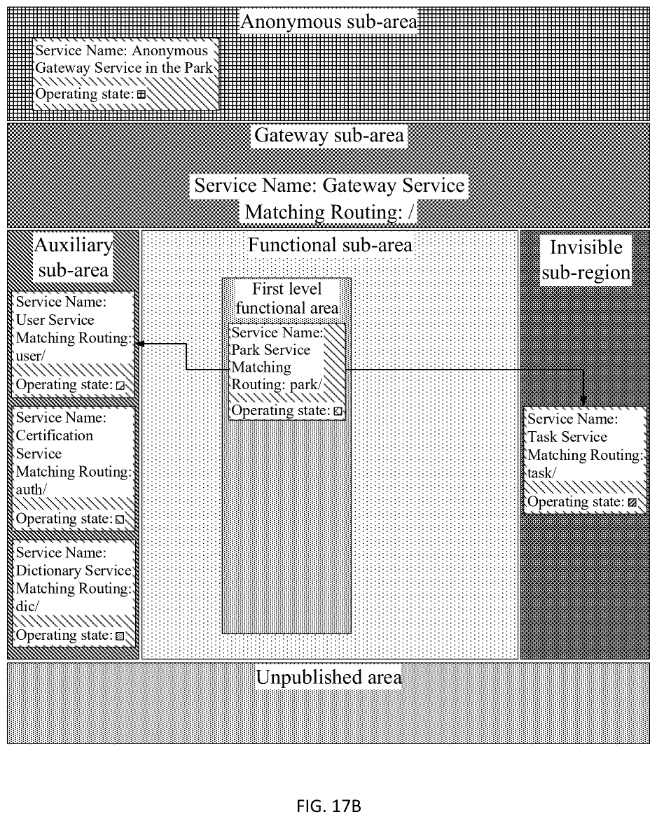

As shown in FIG. 17A to FIG. 17B, this embodiment also provides a configuration interface for anonymous services. After users add the anonymous service corresponding to the park service (the park anonymous gateway service), users drag the anonymous service to the anonymous sub-area, and the system automatically runs the anonymous service. It should be noted that when adding an anonymous service, only the anonymous service of the function service in the currently published area can be added. When operating an anonymous service, the anonymous service can be run only when the function service corresponding to the anonymous service is operating.

In the implementation, when configuring anonymous services, we can also add some configuration information such as Filter, Handler, Adapter and so on in order to achieve the flexibility of the system. While leveraging the commonality of gateways, add plug and play customization functions to make the configuration management of gateways more inclined towards plug-in management. The configuration method is generally the same as the service, and will not be repeated here.

For security reasons, all services must be offline before physical deletion of service configurations can be performed. Services in published areas can only be offline and cannot be deleted, while services in unpublished areas are not restricted from deletion.

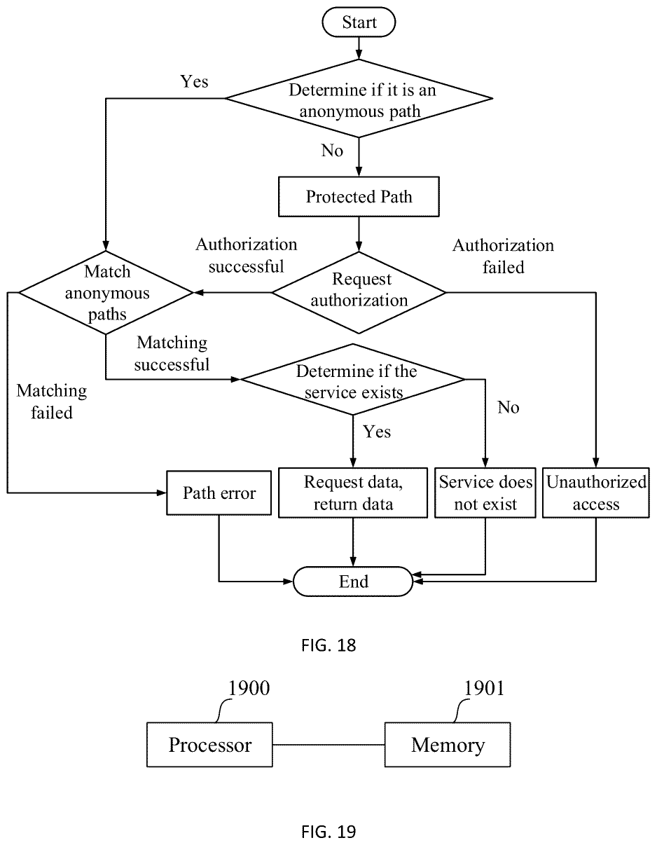

As shown in FIG. 18, this embodiment also provides a flow chart of the operation principle of the gateway service. Firstly, the gateway service judges whether the current requested path is an anonymous path. If it is a path matching (routing matching), it matches the anonymous path. If the matching is consistent, it determines whether the service exists. If the service exists, it requests data and ends after returning the data. Otherwise, it indicates that the service does not exist and ends. If the path matching is inconsistent, it will prompt an error message and end. If the current requested path is not anonymous path, it indicates that it is a protected path and requests authorization. If authorization is successful, path matching will be performed. Otherwise, it will prompt no permission access and end.

The gateway configuration method provided in this embodiment encapsulates all the services involved in the system into modules and places them on the management interface. Users configure the gateway and the relationship between services by dragging and dropping service modules, achieving the effect of “visible and obtainable” gateway configuration, thereby reducing the difficulty of using the system.

This embodiment configures gateway routing through graphical interface drag and drop, avoiding traditional form based gateway configuration. In the operating interface, users can visually see the operating status and distribution of services within the system. Different colors are used to distinguish and display the operating status of the entire system's services, quickly locate service anomalies in the system, reduce service anomaly investigation time, increase the stable operating time of services, allocate hardware resources reasonably, improve the operating efficiency of the system, and thus reduce the maintenance difficulty of complex systems. The entire system is visually presented without being constrained by a single form gateway. It also displays the operational status of the entire system through visualization, reducing the level of maintenance and increasing the stability of system operation. The system has strong adaptability by dragging and dropping services online and offline. The configuration, publication, operation, offline, and deletion processes of services in the entire system incorporate locking principles while being manually operated, greatly increasing the security of operation and maintenance.

Based on the same inventive concept, the present disclosure embodiments also provides an electronic device, the electronic device is the electronic device in the method in the present disclosure embodiments, and the principle of solving the problem with this electronic device is similar to that of this method, so the implementation of this electronic device can refer to the implementation of the method, and any repetition will not be repeated.

As shown in FIG. 19, the electronic device includes a processor 1900 and a memory 1901, the memory 1901 is used to store a program executable by the processor 1900, the processor 1900 is used to read a program in the memory 1901 and execute the following steps:
displaying a service module in a visualization interface, where the visualization interface includes a published area and an unpublished area, the published area is used for displaying a service module of a published service, the unpublished area is used for displaying a service module of an unpublished service;
in response to a user operation of dragging and dropping a target service module from the unpublished area to the published area, configuring a corresponding gateway for the target service module and operating a service corresponding to the target service module, where the target service module is selected by the user from service modules that are not operating in the unpublished area.

As an optional embodiment, the processor 1900 is specifically configured to perform:
configuring corresponding gateway configuration parameters for the target service module according to a calling relationship between the target service module and a service module in the published area.

As an optional embodiment, the processor 1900 is specifically configured to determine a calling relationship between the target service module and a service module in the published area based on any one of the following modes:
determining the calling relationship between the target service module and the service module in the published area based on an upstream service and/or a downstream service in an indicator parameter of the target service module; where the upstream service is used to call a service corresponding to the target service module, and the downstream service is used to be called by a service corresponding to the target service module; or
in response to a manual connection operation by a user of the target service module and the service module in the published area, determining the calling relationship between the target service module and the service module in the published area.

As an optional embodiment, when the calling relationship between the target service module and the service module in the published area is determined based on the upstream service and/or the downstream service in the indicator parameter of the target service module, the processor 1900 is specifically further configured to perform:
connecting the target service module with a service module with a calling relationship through a connecting line to display the calling relationship.

As an optional embodiment, the processor 1900 is specifically further configured to perform:
displaying a directional indicator on the connecting line, where the directional indicator is used to represent a flow of service data of the service module in the calling relationship.

As an optional embodiment, when the calling relationship between the target service module and the service module in the published area is determined in response to the manual connection operation by a user of the target service module and the service module in the published area, the processor 1900 is specifically further configured to perform:
displaying a connecting line corresponding to the manual connection operation;
determining a direction of the connecting line based on a start point and an end point of the manual connection operation; and displaying the direction by means of a directional indicator, where the directional indicator is used to represent a flow of service data of the service module in the calling relationship.

As an optional embodiment, after the directional indicator is displayed on the connecting line, the directional indicator represents the transmission of service data from the target service module to a first service module, the processor 1900 is specifically further configured to perform:
in response to a user operation of dragging and dropping the directional indicator to a second service module, updating a calling relationship between the target service module and the first service module, to a calling relationship between the target service module and the second service module.

As an optional embodiment, the processor 1900 is specifically further configured to perform:
indicating, by means of a display mode of the connecting line, a connection state between a service of the target service module and a corresponding service of the service module in the published area; where the connecting lines of different display modes indicate different connection states.

As an optional embodiment, the service module in the published area comprises a functional service module, the functional service module is used to provide a corresponding functional service for a user object; the published area comprises a functional sub-area, the functional sub-area is used to display the functional service module; the processor 1900 is specifically further configured to perform:
displaying levels of functional services corresponding to the functional service module; where the functional service modules corresponding to different levels of functional services are displayed in different functional areas within the functional sub-areas; in different levels, functional services of higher level can call functional services of lower level.

As an optional embodiment, the processor 1900 is specifically further configured to perform:
in response to a user operation of dragging and dropping a specified service module from the functional sub-area to the unpublished area, adaptively adjusting the levels of functional services corresponding to the functional service module in the functional sub-area; where the specified service module is selected by the user from the functional service modules in the functional sub-area; or,
in response to a user operation of dragging and dropping a target service module from the unpublished area to the functional sub-area, adaptively adjusting the levels of functional services corresponding to the functional service module in the functional sub-area; where the target service module is a functional service module in the unpublished area.

As an optional embodiment, the processor 1900 is specifically configured to perform:
adaptively adjusting the levels of the functional services corresponding to the functional service module according to whether or not an upstream functional service exists for the functional service corresponding to the functional service module, and a maximum level of the upstream functional service when the upstream functional service exists; wherein the upstream functional service is used to call the functional service corresponding to the functional service module.

As an optional embodiment, the processor 1900 is specifically configured to perform:
determining that the level of the functional service corresponding to the functional service module is the maximum level, in a case that the functional service corresponding to the functional service module does not have upstream functional services; or
determining a level of the functional service corresponding to the functional service module according to a maximum level of the upstream functional service, in a case that there are upstream functional services for the functional service corresponding to the functional service module.

As an optional embodiment, the service module includes any one or more types of the service module as follows:
a functional service module, representing functional services that provide functionality to the user;
an anonymous service module, representing anonymous services that provide functionality for functional services, wherein the anonymous service does not require permission authentication when accessing functional services;
an auxiliary service module, representing auxiliary services that provide functionality for functional services;
an invisible service module, representing invisible services that provide functionality for functional services, wherein the invisible services are not visible to the public;
a gateway service module, representing the management of all services except for itself.

As an optional embodiment, the processor 1900 is specifically further configured to perform:
displaying at least one of a service name, a service type, an operation state, and a gateway configuration parameter of a service corresponding to the service module in the visualization interface; wherein the service type is determined based on a function provided by the service; and the operation state indicates a load balancing state of the service.

As an optional embodiment, when the operation states of a service corresponding to the service module is displayed, the display modes of different operation states are different, and displayed operation states are used to prompt users to allocate hardware resources reasonably.

As an optional embodiment, the processor 1900 is specifically further configured to perform:
displaying the published area and the unpublished area in different modes;
where the display mode of a service module in the unpublished area is determined according to a service type of the service module, and service modules of different service types are displayed differently in the unpublished area.

As an optional embodiment, the published area includes a plurality of sub-areas, the sub-areas includes functional sub-areas; the processor 1900 is specifically further configured to perform:
each sub-area is used to display service modules of the same service type; different sub-areas are used to display service modules of different service types; different sub-areas are displayed in different modes.

As an optional embodiment, in response to the operation of the user dragging and dropping the target service module from the unpublished area to the published area, the processor 1900 is specifically further configured to perform:
activating, based on the service type of the target service module, a sub-area in the published area with the same service type as the service type, for prompting a user to drag and drop the target service module to an activated sub-area.

As an optional embodiment, the processor 1900 is specifically further configured to perform:
displaying a service configuration interface in response to a service addition operation by a user in the visualization interface, where the service configuration interface is used to display a plurality of indicators of a service;
in response to indicator parameters of the plurality of indicators inputted by the user, generating and displaying a service module in the unpublished area.

As an optional embodiment, the indicator parameter includes service types, one service type corresponding to one display mode; the processor 1900 is specifically configured to perform:
according to the display mode corresponding to the service type in the indicator parameter inputted by the user, display the service module in the unpublished area according to the display mode corresponding to the service type.

As an optional embodiment, the processor 1900 is specifically configured to perform:
in response to the service addition operation by the user in the visualization interface, displaying the service configuration interface according to a service type of a service corresponding to the service addition operation;
where at least one of the plurality of indicators displayed in the service configuration interface corresponding to the different service types is different.

As an optional embodiment, the indicators include any one or more of:
a service name; a service type; a IP or domain name; a port; a path; a handler; a filter; an edition; an ancillary service; an upstream service; a downstream service; an invisible service; an auxiliary path; an anonymous path; a request mode.

As an optional embodiment, the processor 1900 is specifically further configured to perform:
in response to a user operation of dragging and dropping a specified service module to the unpublished area, controlling a service corresponding to the specified service module to be converted from an operational state to an inoperational state, and deleting a gateway configuration parameter corresponding to the specified service module;
where the specified service module is selected by the user from the service modules in the published area.

As an optional embodiment, the processor 1900 is specifically further configured to perform:
in response to a deletion operation of a service module in the unpublished area by a user, deleting configuration data corresponding to the service module, wherein the configuration data comprises gateway configuration parameters.

As an optional embodiment, before displaying the service module in the visualization interface, the processor 1900 is specifically further configured to perform:
in response to a configuration operation of the visualization interface by a user, configuring, in the visualization interface, at least one of a number of areas, a name of an area, a location of an area, a display mode of an area, a size of an area, a service module displayed in an area, and a service type of a service module displayed in an area.

As an optional embodiment, a service module displayed in the visualization interface is used to represent a service in a micro-service architecture;
the gateway configuration is used for access control and management of services in the micro-service architecture.

Based on the same inventive concept, the present disclosure embodiments also provides an electronic device, the electronic device is the electronic device in the method in the present disclosure embodiments, and the principle of solving the problem with this electronic device is similar to that of this method, so the implementation of this electronic device can refer to the implementation of the method, and any repetition will not be repeated.

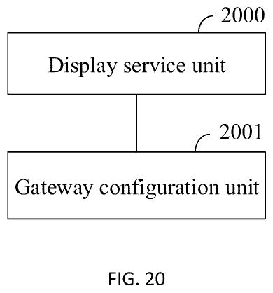

As shown in FIG. 20, the device includes:
a display service unit 2000, configured to display a service module in a visualization interface, where the visualization interface comprises a published area and an unpublished area, the published area is used for displaying a service module of a published service, the unpublished area is used for displaying a service module of an unpublished service;
a gateway configuration unit 2001, configured to configure a corresponding gateway for the target service module and operate a service corresponding to the target service module in response to a user operation of dragging and dropping a target service module from the unpublished area to the published area; where the target service module is selected by the user from service modules that are not operating in the unpublished area.

As an optional embodiment, the gateway configuration unit 2001 is specifically configured to:
configure corresponding gateway configuration parameters for the target service module according to a calling relationship between the target service module and a service module in the published area.

As an optional embodiment, the gateway configuration unit 2001 is specifically configured to determine a calling relationship between the target service module and a service module in the published area based on any one of the following modes:
determine the calling relationship between the target service module and the service module in the published area based on an upstream service and/or a downstream service in an indicator parameter of the target service module; where the upstream service is used to call a service corresponding to the target service module, and the downstream service is used to be called by a service corresponding to the target service module; or
in response to a manual connection operation by a user of the target service module and the service module in the published area, determine the calling relationship between the target service module and the service module in the published area.

As an optional embodiment, when the calling relationship between the target service module and the service module in the published area is determined based on the upstream service and/or the downstream service in the indicator parameter of the target service module, the gateway configuration unit 2001 is specifically further configured to:
connect the target service module with a service module with a calling relationship through a connecting line to display the calling relationship.

As an optional embodiment, the gateway configuration unit 2001 is specifically further used to:
display a directional indicator on the connecting line, where the directional indicator is used to represent a flow of service data of the service module in the calling relationship.

As an optional embodiment, when the calling relationship between the target service module and the service module in the published area is determined in response to the manual connection operation by a user of the target service module and the service module in the published area, the gateway configuration unit 2001 is specifically further configured to:
display a connecting line corresponding to the manual connection operation;
determine a direction of the connecting line based on a start point and an end point of the manual connection operation; and display the direction by means of a directional indicator, where the directional indicator is used to represent a flow of service data of the service module in the calling relationship.

As an optional embodiment, after the directional indicator is displayed on the connecting line, the directional indicator represents the transmission of service data from the target service module to a first service module, the gateway configuration unit 2001 is specifically further configured to:
in response to a user operation of dragging and dropping the directional indicator to a second service module, update a calling relationship between the target service module and the first service module, to a calling relationship between the target service module and the second service module.

As an optional embodiment, the gateway configuration unit 2001 is specifically further configured to:
indicate, by means of a display mode of the connecting line, a connection state between a service of the target service module and a corresponding service of the service module in the published area; where the connecting lines of different display modes indicate different connection states.

As an optional embodiment, the service module in the published area includes a functional service module, the functional service module is used to provide a corresponding functional service for a user object; the published area includes a functional sub-area, the functional sub-area is used to display the functional service module; the display service unit 2000 is specifically further configured to:
display levels of functional services corresponding to the functional service module; where the functional service modules corresponding to different levels of functional services are displayed in different functional areas within the functional sub-areas; in different levels, functional services of higher level can call functional services of lower level.

As an optional embodiment, the display service unit 2000 is specifically further configured to:
in response to a user operation of dragging and dropping a specified service module from the functional sub-area to the unpublished area, adaptively adjust the levels of functional services corresponding to the functional service module in the functional sub-area; where the specified service module is selected by the user from the functional service modules in the functional sub-area; or,
in response to a user operation of dragging and dropping a target service module from the unpublished area to the functional sub-area, adaptively adjust the levels of functional services corresponding to the functional service module in the functional sub-area; where the target service module is a functional service module in the unpublished area.

As an optional embodiment, the display service unit 2000 is specifically configured to:
adaptively adjust the levels of the functional services corresponding to the functional service module according to whether or not an upstream functional service exists for the functional service corresponding to the functional service module, and a maximum level of the upstream functional service when the upstream functional service exists; where the upstream functional service is used to call the functional service corresponding to the functional service module.

As an optional embodiment, the display service unit 2000 is specifically configured to:
determine that the level of the functional service corresponding to the functional service module is the maximum level, in a case that the functional service corresponding to the functional service module does not have upstream functional services; or
determine a level of the functional service corresponding to the functional service module according to a maximum level of the upstream functional service, in a case that there are upstream functional services for the functional service corresponding to the functional service module.

As an optional embodiment, the service module includes any one or more types of the service module as follows:
a functional service module, representing functional services that provide functionality to the user;
an anonymous service module, representing anonymous services that provide functionality for functional services, where the anonymous service does not require permission authentication when accessing functional services;
an auxiliary service module, representing auxiliary services that provide functionality for functional services;
an invisible service module, representing invisible services that provide functionality for functional services, wherein the invisible services are not visible to the public;
a gateway service module, representing the management of all services except for itself.

As an optional embodiment, the display service unit 2000 is specifically further used to:
display at least one of a service name, a service type, an operation state, and a gateway configuration parameter of a service corresponding to the service module in the visualization interface; where the service type is determined based on a function provided by the service; and the operation state indicates a load balancing state of the service.

As an optional embodiment, when the operation states of a service corresponding to the service module is displayed, the display modes of different operation states are different, and displayed operation states are used to prompt users to allocate hardware resources reasonably.

As an optional embodiment, the display service unit 2000 is specifically further configured to:
display the published area and the unpublished area in different modes;
where the display mode of a service module in the unpublished area is determined according to a service type of the service module, and service modules of different service types are displayed differently in the unpublished area.

As an optional embodiment, the published area includes a plurality of sub-areas, the sub-areas includes functional sub-areas; the display service unit 2000 is specifically further configured to:
each sub-area is used to display service modules of the same service type; different sub-areas are used to display service modules of different service types; different sub-areas are displayed in different modes.

As an optional embodiment, in response to the operation of the user dragging and dropping the target service module from the unpublished area to the published area, the display service unit 2000 is specifically further configured to:
activate, based on the service type of the target service module, a sub-area in the published area with the same service type as the service type, for prompting a user to drag and drop the target service module to an activated sub-area.

As an optional embodiment, the display service unit 2000 is specifically further configured to:
display a service configuration interface in response to a service addition operation by a user in the visualization interface, where the service configuration interface is used to display a plurality of indicators of a service;
in response to indicator parameters of the plurality of indicators inputted by the user, generate and display a service module in the unpublished area.

As an optional embodiment, the indicator parameter includes service types, one service type corresponding to one display mode;
according to the display mode corresponding to the service type in the indicator parameter inputted by the user, display the service module in the unpublished area according to the display mode corresponding to the service type.

As an optional embodiment, the display service unit 2000 is specifically further configured to:
in response to the service addition operation by the user in the visualization interface, display the service configuration interface according to a service type of a service corresponding to the service addition operation;
where at least one of the plurality of indicators displayed in the service configuration interface corresponding to the different service types is different.

As an optional embodiment, the indicator includes any one or more of the following:
a service name; a service type; a IP or domain name; a port; a path; a handler; a filter; an edition; an ancillary service; an upstream service; a downstream service; an invisible service; an auxiliary path; an anonymous path; a request mode.

As an optional embodiment, the gateway configuration unit 2001 is specifically further configured to:
in response to a user operation of dragging and dropping a specified service module to the unpublished area, control a service corresponding to the specified service module to be converted from an operational state to an inoperational state, and delete a gateway configuration parameter corresponding to the specified service module;
where the specified service module is selected by the user from the service modules in the published area.

As an optional embodiment, the gateway configuration unit 2001 is specifically further configured to:
in response to a deletion operation of a service module in the unpublished area by a user, delete configuration data corresponding to the service module, where the configuration data comprises gateway configuration parameters.

As an optional embodiment, before displaying the service module in the visualization interface, the gateway configuration unit 2001 is specifically further configured to:
in response to a configuration operation of the visualization interface by a user, configure, in the visualization interface, at least one of a number of areas, a name of an area, a location of an area, a display mode of an area, a size of an area, a service module displayed in an area, and a service type of a service module displayed in an area.

As an optional embodiment, a service module displayed in the visualization interface is used to represent a service in a micro-service architecture;
the gateway configuration is used for access control and management of services in the micro-service architecture.

Based on the same inventive concept, embodiments of the present disclosure provide a computer storage medium, the computer storage medium includes: computer program codes, when the computer program codes are run on a computer, the computer performs a gateway configuration method as discussed in the above description. As the above computer storage media to solve the problem of the principle and gateway configuration method is similar, the implementation of the above computer storage media can be seen in the implementation of the method, and the repetition will not be repeated.

In the specific implementation, the computer storage media can include: Universal Serial Bus Flash Drive (USB), mobile hard disk, Read Only Memory (ROM), Random Access Memory (RAM), magnetic disk or optical disk and other storage media that can store program code.

Based on the same inventive concept, embodiments of the present disclosure also provide a computer program product, the computer program product includes: computer program codes, when the computer program codes are run on a computer, the computer performs a gateway configuration method as discussed above. Since the above computer program product to solve the problem of the principle and the gateway configuration method is similar, the implementation of the above computer program product can be seen in the implementations of the method, and the repetition will not be repeated.

A computer program product may adopt any combination of one or more readable media. The readable medium may be a readable signal medium or a readable storage medium. The readable storage medium may be, for example, but is not limited to electrical, magnetic, optical, electromagnetic, infrared, or semiconductor systems, devices, or devices, or any combination of the above. More specific examples of readable storage media (non-exhaustive list) include: electrical connection with one or more wires, portable disk, hard disk, random access memory (RAM), read-only memory (ROM), erasable programmable read-only memory (EPROM or flash memory), optical fiber, portable compact disk read-only memory (CD-ROM), optical storage device, magnetic storage device or any suitable combination of the above.

It should be appreciated by those skilled in the art that embodiments of the present disclosure may be provided as methods, systems, or computer program products. Accordingly, the present disclosure may take the form of an entirely hardware embodiment, an entirely software embodiment, or an embodiment combining software and hardware aspects. Furthermore, the present disclosure may take the form of a computer program product embodied on one or more computer-usable storage medium (including but not limited to a disk storage, an optical storage, and the like) having computer-usable program code embodied therein.

The present disclosure is described with reference to flowchart illustrations and/or block diagrams of methods, apparatus (systems), and computer program products according to embodiments of the present disclosure. It will be understood that each flow and/or block in the flowchart illustrations and/or block diagrams, and combinations of flows and/or blocks in the flowchart illustrations and/or block diagrams, can be implemented by computer program instructions. These computer program instructions may be provided to the processor of a general purpose computer, a special purpose computer, an embedded processor or other programmable data processing device to produce a machine, such that the instructions executed by the processor of the computer or other programmable data processing device produce devices for implementing the functions specified in a flow or flow of a flowchart and/or a block or blocks of a block diagram.

These computer program instructions may also be stored in a computer-readable memory capable of directing a computer or other programmable data processing apparatus to function in a particular manner, such that the instructions stored in the computer-readable memory result in an article of manufacture including instruction devices, the instructions device implements the functions specified in one or more flows of the flowchart and/or one or more blocks of the block diagrams.

These computer program instructions can also be loaded on a computer or other programmable data processing device to cause a series of operational steps to be performed on the computer or other programmable device to produce a computer-implemented process, such that the instructions performed on the computer or other programmable device provide steps for implementing the functions specified in the one or more flows of the flowcharts and/or one or more blocks of the block diagrams.

Evidently those skilled in the art can make various modifications and variations to the present disclosure without departing from the spirit and scope of the present disclosure. Thus the present disclosure is also intended to encompass these modifications and variations therein as long as these modifications and variations to the present disclosure come into the scope of the claims of the present disclosure and their equivalents.

1-28. (canceled)

29. A gateway configuration method, comprising:
displaying a service module in a visualization interface, wherein the visualization interface comprises a published area and an unpublished area, the published area is used for displaying a service module of a published service, the unpublished area is used for displaying a service module of an unpublished service;
in response to a user operation of dragging and dropping a target service module from the unpublished area to the published area, configuring a corresponding gateway for the target service module and operating a service corresponding to the target service module, wherein the target service module is selected by the user from service modules that are not operating in the unpublished area.

30. The method according to claim 29, wherein the configuring the corresponding gateway for the target service module, comprises:
configuring corresponding gateway configuration parameters for the target service module according to a calling relationship between the target service module and a service module in the published area.

31. The method according to claim 30, wherein the calling relationship between the target service module and the service module in the published area is determined based on any one of following modes:
determining the calling relationship between the target service module and the service module in the published area based on an upstream service and/or a downstream service in an indicator parameter of the target service module; wherein the upstream service is used to call a service corresponding to the target service module, and the downstream service is used to be called by a service corresponding to the target service module; or
in response to a manual connection operation by a user of the target service module and the service module in the published area, determining the calling relationship between the target service module and the service module in the published area.

32. The method according to claim 31, wherein in response to the calling relationship between the target service module and the service module in the published area being determined based on the upstream service and/or the downstream service in the indicator parameter of the target service module, the method further comprises:
connecting the target service module with a service module with a calling relationship through a connecting line to display the calling relationship; or
in response to the calling relationship between the target service module and the service module in the published area being determined in response to the manual connection operation by a user of the target service module and the service module in the published area, the method further comprises:
displaying a connecting line corresponding to the manual connection operation;
determining a direction of the connecting line based on a start point and an end point of the manual connection operation; and displaying the direction by a directional indicator, wherein the directional indicator is used to represent a flow of service data of the service module in the calling relationship.

33. The method according to claim 32, further comprising:
displaying a directional indicator on the connecting line, wherein the directional indicator is used to represent a flow of service data of the service module in the calling relationship.

34. The method according to claim 33, wherein after the directional indicator is displayed on the connecting line, the directional indicator represents the transmission of service data from the target service module to a first service module, the method further comprises:
in response to a user operation of dragging and dropping the directional indicator to point to a second service module, updating the calling relationship between the target service module and the first service module, to a calling relationship between the target service module and the second service module.

35. The method according to claim 32, further comprising:
indicating, by means of a display mode of the connecting line, a connection state between a service of the target service module and a corresponding service of the service module in the published area; wherein the connecting lines of different display modes indicate different connection states.

36. The method according to claim 29, wherein the service module in the published area comprises a functional service module, the functional service module is used to provide a corresponding functional service for a user object; the published area comprises a functional sub-area, the functional sub-area is used to display the functional service module; wherein the method further comprises:
displaying levels of functional services corresponding to the functional service module; wherein the functional service modules corresponding to different levels of functional services are displayed in different functional areas within the functional sub-areas; in different levels of functional services, functional services of higher level calls functional services of lower level.

37. The method according to claim 36, further comprising:
in response to a user operation of dragging and dropping a specified service module from the functional sub-area to the unpublished area, adaptively adjusting the levels of functional services corresponding to the functional service module in the functional sub-area; wherein the specified service module is selected by the user from the functional service modules in the functional sub-area; or,
in response to a user operation of dragging and dropping a target service module from the unpublished area to the functional sub-area, adaptively adjusting the levels of functional services corresponding to the functional service module in the functional sub-area; wherein the target service module is a functional service module in the unpublished area.

38. The method according to claim 37, wherein the adaptively adjusting the levels of functional services corresponding to the functional service module in the functional sub-area, comprises:
adaptively adjusting the levels of the functional services corresponding to the functional service module according to whether or not an upstream functional service exists for the functional service corresponding to the functional service module, and a maximum level of the upstream functional service in response to the upstream functional service existing; wherein the upstream functional service is used to call the functional service corresponding to the functional service module.

39. The method according to claim 38, wherein the adaptively adjusting the levels of the functional services corresponding to the functional service module, comprises:
determining that the level of the functional service corresponding to the functional service module is the maximum level, in a case that the functional service corresponding to the functional service module does not have the upstream functional service; or
determining a level of the functional service corresponding to the functional service module according to a maximum level of the upstream functional service, in a case that there is the upstream functional service for the functional service corresponding to the functional service module.

40. The method according to claim 29, wherein the service module comprises any one or more types of service module as follows:
a functional service module, representing functional services that provide functionality to the user;
an anonymous service module, representing anonymous services that provide functionality for functional services, wherein the anonymous service does not require permission authentication in response to an accessing function serving;
an auxiliary service module, representing auxiliary services that provide functionality for functional services;
an invisible service module, representing invisible services that provide functionality for functional services, wherein the invisible services are not visible to the public;
a gateway service module, representing a management of all services except for itself.

41. The method according to claim 29, further comprising.
displaying at least one of a service name, a service type, an operation state, or a gateway configuration parameter of a service corresponding to the service module in the visualization interface; wherein the service type is determined based on a function provided by the service; and the operation state indicates a load balancing state of the service.

42. The method according to claim 41, wherein:
in response to the operation state of a service corresponding to the service module being displayed, display modes of different operation states are different, and displayed operation states are used to prompt users to allocate hardware resources reasonably.

43. The method according to claim 29, further comprising:
displaying the published area and the unpublished area in different modes;
wherein the display mode of a service module in the unpublished area is determined according to a service type of the service module, and service modules of different service types are displayed differently in the unpublished area.

44. The method according to claim 29, wherein the published area comprises a plurality of sub-areas, the sub-areas comprises functional sub-areas; the method further comprises:
using each sub-area to display service modules of the same service type; using different sub-areas to display service modules of different service types; different sub-areas are displayed in different modes.

45. The method according to claim 44, wherein, in response to the operation of the user dragging and dropping the target service module from the unpublished area to the published area, the method further comprises:
activating, based on the service type of the target service module, a sub-area in the published area of a service type same as the service type, for prompting a user to drag and drop the target service module to an activated sub-area.

46. The method according to claim 29, further comprising:
displaying a service configuration interface in response to a service addition operation by a user in the visualization interface, wherein the service configuration interface is used to display a plurality of indicators of a service;
in response to indicator parameters of the plurality of indicators inputted by the user, generating and displaying a service module in the unpublished area.

47. The method according to claim 46, wherein the indicator parameter comprises service types, one service type corresponding to one display mode;
according to the display mode corresponding to the service type in the indicator parameter inputted by the user, displaying the service module in the unpublished area according to the display mode corresponding to the service type; or
the displaying a service configuration interface in response to a service addition operation by a user in the visualization interface, comprises:
in response to the service addition operation by the user in the visualization interface, displaying the service configuration interface according to a service type of a service corresponding to the service addition operation;
wherein at least one of the plurality of indicators displayed in the service configuration interfaces corresponding to the different service types are different; or
the indicators comprise any one or more of the following:
a service name; a service type; a IP or domain name; a port; a path; a handler; a filter; an edition; an ancillary service; an upstream service; a downstream service; an invisible service; an auxiliary path; an anonymous path; a request mode.

48. The method according to claim 29, further comprising:
in response to a user operation of dragging and dropping a specified service module to the unpublished area, controlling a service corresponding to the specified service module to be converted from an operational state to an inoperational state, and deleting a gateway configuration parameter corresponding to the specified service module;
wherein the specified service module is selected by the user from the service modules in the published area; or
in response to a deletion operation of a service module in the unpublished area by a user, deleting configuration data corresponding to the service module, wherein the configuration data comprises gateway configuration parameters; or
before displaying the service module in the visualization interface, the method further comprises:
in response to a configuration operation of the visualization interface by a user, configuring, in the visualization interface, at least one of a quantity of areas, a name of an area, a location of an area, a display mode of an area, a size of an area, a service module displayed in an area, or a service type of a service module displayed in an area; or
the service module displayed in the visualization interface is used to represent a service in a micro-service architecture;
the gateway configuration is used for access control and management of services in the micro-service architecture.
